(19) United States
(12) Patent Application Publication
(10) Pub. No.: US 2006/0125968 A1
(43) Pub. Date: Jun. 15, 2006

(54) Control system, apparatus compatible with the system, and remote controller

(75) Inventors: Yukio Yokozawa, Shiojiri (JP); Hiroyuki Yokoyama, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/299,338

(22) Filed: Dec. 9, 2005

(30) Foreign Application Priority Data
Dec. 10, 2004 (JP) 2004-357715
Dec. 14, 2004 (JP) 2004-361006

(51) Int. Cl. H04N 5/44

(52) U.S. Cl. 348/734

(57) ABSTRACT

A control system includes a remote controller and an apparatus capable of being controlled by the remote controller, wherein the remote controller comprises: a housing formed separately from the apparatus; an image pickup section provided in the housing and adapted to be capable of generating image information including information contributing to recognition of a relative position of the apparatus to the remote controller when imaging is performed toward the side of the apparatus; and an information transmitting section transmitting image information generated by the image pickup section to the side of the apparatus, and the apparatus comprises: an information receiving section adapted to be capable of receiving image information transmitted from the information transmitting section of the remote controller; and a relative position calculating section calculating a relative position of the apparatus to the remote controller based on image information received by the information receiving section.

The entire disclosure of Japanese Patent Application Nos. 2004-357715 and 2004-361006, filed Dec. 10, 2004 and Dec. 14, 2004, respectively, are expressly incorporated by reference.

### FIELD OF THE INVENTION

The present invention relates to a television receiver as an example of an apparatus, a control system constituted by a remote controller or the like as an example of a remote controller corresponding to the apparatus, an apparatus compatible with the system, and a remote controller.

### BACKGROUND OF THE INVENTION

Many techniques for multi-functionalizing a remote controller to provide various conveniences to users for operations of a system constituted by the remote controller and devices remotely operated by the remote controller have been proposed.

For example, JP-A-2004-166193 discloses a technique for detecting the position of itself based on reception of electric waves from three electric wave sources and on the time of reception using an algorithm for GPS by a remote controller, checking information of the detected position against information of the positions of devices previously prepared to specify a device closest to itself, acquiring information defining remote control signal from the device and information for constructing an image for operations, displaying an image for operations of the specified device on a display portion, and specifying a remote control signal according to a user operation and making a remote control signal transmission controlling portion control transmission, whereby a user can more precisely specify a device to be controlled and control the device without increasing the number of button operations by the user.

JP-A-2004-187052 proposes an image processing system operating a projector by a remote controller, wherein on the projector side, projection region image pickup information and orientation information acquired by the remote controller having an image pickup element is received by its own reception portion, a trapezoidal distortion correction value previously prepared in a lookup table is selected depending on the received information, and the trapezoidal distortion is corrected based on the correction value.

Further, JP-A-2001-236181 proposes a pointing device pointing to any point on a display screen by a laser pointer, wherein a display screen including a laser spot from a remote controller is imaged by a CCD camera provided on the remote controller side, coordinates of the laser spot are calculated depending on raster scanning of an image by the imaging or the like, data representing the coordinates is wirelessly transmitted from the remote controller side to the television side, and an indicating point is projected on a screen, whereby pointing can be done from various angles.

In relation to the proposition in JP-A-2001-236181 described above, JP-A-2003-208260 proposes that coordinates of an actual screen raster which central coordinates of a picked-up image correspond to are calculated based on comparison between coordinates of positions of three corners on an image display plane on a raster imaged by an image pickup apparatus provided on the remote controller side and coordinates of positions of three corners on an actual image display plane, whereby pointing can be done on a display screen without projecting a laser spot or the like from the remote controller side.

The conventional technique described above has a various problems as described below in terms of making it possible to select contents and adjust acoustic effects so as to be compatible with the position of a user having a remote controller. Namely, in the technique in JP-A-2004-166193, it is essential to previously install three electric wave sources as a reference for position detection in principle, and therefore it is difficult to select as a control object a device having a relatively simple configuration and meeting user's requests with an appropriate certainty. In the proposition in JP-A-2004-166193, some device closest to the position of the remote controller (namely, user having the remote controller) is unconditionally selected as a control object, and therefore a device matching a proper intention of the user is not always selected. Thus, the user himself must approach the device when it is actually used, and a control object intended for operation cannot be expected to be literally automatically selected.

In the technique proposed in JP-A-2004-187052, orientation information of the remote controller is acquired as long as it is required for correcting a trapezoidal distortion in the projector, and the trapezoidal distortion is corrected based on the acquired orientation information, and thus there is no indicative disclosure as for recognizing the position of the remote controller (hence user) in relation to a device main body and selecting contents and adjusting acoustic effects so as to be compatible with the recognition.

Further, in the proposition in JP-A-2001-236181, persistently, the display screen including a projected laser spot is imaged by an image pickup section on the remote controller side, and data of coordinates of the position of the laser spot is acquired based on raster scanning associated with an image signal by the imaging, and thus this is different in spirit from the technique of recognizing the position of the remote controller in relation to the device main body and selecting contents and adjusting acoustic effects so as to be compatible with the recognition.

In the proposition in JP-A-2003-208260, pointing can only be done on the display screen without projecting a laser spot or the like from the remote controller side as in JP-A-2001-236181, and although the technique is intended to solve the problems in the technique described in JP-A-2001-236181, no proposition is made for recognizing the position of the remote controller in relation to the device main body and selecting contents and adjusting acoustic effects so as to be compatible with the recognition.

Any of techniques described in the patent documents described above gives no useful indication in terms of making it possible to estimate a user (viewer of an image and sound apparatus as an apparatus to be controlled) from a feature of a travel trail of the remote controller and select contents compatible with the user, and to estimate the position of a viewer highly possibly situated at a location substantially coinciding a location at which the remote controller exists and adjust acoustic effects so as to be compatible with the position of the remote controller (hence user having the remote controller).

The present invention has been made in view of the problems in the conventional techniques described above, and an object of the present invention is to provide a control system making it possible to recognize the position of the remote controller in relation to the apparatus making use of the image pickup section provided on the remote controller side, and hence making it possible to perform an automatic response operation of, for example, selecting contents and adjusting acoustic effects in the apparatus so as to be compatible with the recognition, an apparatus compatible with the system, and a remote controller.

Further, an object of the present invention is to provide a control system making it possible to provide a relative position detecting section, for example so called a gyro, detecting in a noncontact manner a relative change in its position on the remote controller side to recognize the travel trail and a current position of the remote controller from an output of detection by the relative position detecting section, and hence making it possible to provide various conveniences for the handling of a relevant apparatus based on the recognition, for example to select contents and adjust acoustic effects in the apparatus so as to be compatible with the recognized current position, an apparatus compatible with the system, and a remote controller.

### SUMMARY

The invention is defined by the claims. The invention, in its broader aspects, provide a control system, an apparatus compatible with the system, and a remote controller for controlling the apparatus based on a relative position of the remote controller to the apparatus. In the control system inclusive of the control apparatus and the remote controller, it is obtainable that a data for a position of the remote controller representing a position of a user. The remote controller controls the apparatus based on the data.

According to an aspect of the present invention is provided a control system comprising a remote controller and an apparatus capable of being controlled by the remote controller,

wherein the remote controller comprises:

a housing formed separately from the apparatus;

an image pickup section provided in the housing and adapted to be capable of generating image information including information contributing to recognition of a relative position of the apparatus to the remote controller when imaging is performed toward the side of the apparatus; and

an information transmitting section transmitting the image information generated by the image pickup section to the side of the apparatus, and

the apparatus comprises:

an information receiving section adapted to be capable of receiving the image information transmitted from the information transmitting section of the remote controller; and

a relative position calculating section calculating a relative position of the apparatus to the remote controller based on the image information received by the information receiving section.

It is an advantageous effect of at least some of the embodiments of the invention for an improved control system mentioned above that imaging is performed in an imaging field of view including the apparatus making use of the image pickup section provided on the remote controller side, and image information acquired by the imaging is transmitted to the apparatus, whereby a relative position of the remote controller to the apparatus can be calculated on the side of the apparatus receiving the transmitted image information by the information receiving apparatus. On the side of the apparatus recognizing the calculated position of the remote controller, an operation of a state compatible with the recognition can be performed.

According to another aspect of the present invention is provided an apparatus configured to be capable of being controlled from a predetermined remote controller formed separately from the apparatus, comprising:

an information receiving section adapted to be capable of receiving image information generated by an image pickup section provided in the remote controller and including information contributing to recognition of a relative position of the apparatus to the remote controller when the image information is transmitted from the side of the remote controller; and

a relative position calculating section calculating the relative position of the apparatus to the remote controller based on the image information received by the information receiving section.

It is an advantageous effect of at least some of the embodiments of the invention for an improved apparatus mentioned above that when image information including information contributing to recognition of the relative position of the apparatus to the remote controller is transmitted from the side of the remote controller, the transmitted image information is received by its own information receiving section, and the relative position of the apparatus to the remote controller by the relative position calculating section based on the received image information. The calculated position of the remote controller can be recognized, and an operation compatible with the recognition can be performed.

According to a further aspect of the present invention is provided a remote controller adapted to be capable of performing predetermined control of an apparatus and formed separately of the apparatus, comprising:

an image pickup section provided in its own housing to be capable of generating image information including information contributing to recognition of a relative position of the apparatus to the remote controller when imaging is performed toward the side of the apparatus; and

an information transmitting section transmitting image information generated by the image pickup section to the side of the apparatus.

It is an advantageous effect of at least some of the embodiments of the invention for an improved remote controller mentioned above that imaging can be performed in an imaging field of view including the apparatus making use of its own image pickup section, and image information acquired by the imaging can be transmitted to the apparatus by the information transmitting section. On the side of the apparatus receiving the transmitted image information, the position of the remote controller can be calculated in relation to the apparatus, the calculated position of the remote controller can be recognized, and an operation of an aspect compatible with the recognition can be performed.

According to a still further aspect of the present invention is provided a control system comprising a remote controller and an apparatus capable of being controlled by the remote controller,

wherein the remote controller comprises:

a housing formed separately from the apparatus;

an image pickup section provided in the housing and adapted to be capable of generating image information including information contributing to recognition of a relative position of the apparatus to the remote controller when imaging is performed toward the side of the apparatus;

a communication section communicating with an external information processing apparatus; and

an information acquiring and transmitting section transferring the image information generated by the image pickup section to the image processing apparatus through the communication section, acquiring relevant information related to the apparatus, supplied from the information processing apparatus as a response to the transfer, and transmitting the relevant information to the side of the apparatus, and

the apparatus comprises:

an information receiving section adapted to be capable of receiving the relevant information transmitted from the information acquiring and transmitting section of the remote controller;

a relative position recognizing section recognizing a relative position of the apparatus to the remote controller using the relevant information received by the information receiving section; and

an adjustment section performing a predetermined adjustment operation based on the recognition by the relative position recognizing section.

It is an advantageous effect of at least some of the embodiments of the invention for an improved control system mentioned above that image information related to the apparatus, acquired by imaging in the remote controller, is supplied to the external image processing apparatus through the communication section, relevant information of sufficient contents related to the apparatus is acquired without excessively increasing a burden on itself by using a high information acquirement processing capability by the information processing apparatus, and the relevant information is transmitted to the side of the apparatus by the information acquiring and transmitting section. On the side of the apparatus, the relative position of the apparatus to the remote controller can be recognized using the relevant information by the transmission, and an operation of a proper state can be performed based on the recognition.

According to another aspect of the present invention is provided an apparatus configured to be capable of being controlled from a predetermined remote controller formed separately from the apparatus, comprising:

an information receiving section adapted to be capable of transferring image information generated by the remote controller with its image pickup section to an external image processing apparatus through its own communication section and receiving relevant information related to the apparatus, acquired from the information processing apparatus as a response to the transfer;

a relative position recognizing section recognizing a relative position of the apparatus to the remote controller using the relevant information received by the information receiving section; and

an adjustment section performing a predetermined adjustment operation based on recognition by the relative position recognizing section.

It is an advantageous effect of at least some of the embodiments of the invention for an improved apparatus mentioned above that relevant information of sufficient contents related to the apparatus, acquired in liaison with the external image processing having a relatively high information acquirement processing capability in the remote controller, can be received by its own information receiving section, the relative position to the remote controller can be recognized by the received relevant information of sufficient contents related to the apparatus, and an operation of a proper state can be performed based on the recognition.

According to a further aspect of the present invention is provided a remote controller adapted to be capable of performing predetermined control of an apparatus and formed separately from the apparatus, comprising:

an image pickup section provided in its own housing to be capable of generating image information including information contributing to recognition of a relative position of the apparatus to the remote controller when imaging is performed toward the side of the apparatus;

a communication section communicating with an external information processing apparatus; and

an information acquiring and transmitting section transferring image information generated by the image pickup section to the information processing apparatus through the communication section, acquiring relevant information related to the apparatus, supplied from the information processing apparatus as a response to the transfer, and transmitting the relevant information to the side of the apparatus.

It is an advantageous effect of at least some of the embodiments of the invention for an improved remote controller mentioned above that image information related to the apparatus, acquired by imaging by its own image pickup section, is supplied to the external information processing apparatus through the communication section, relevant information of sufficient contents related to the apparatus is acquired without excessively increasing a burden on itself by using a high information acquirement processing capability by the information processing apparatus, and the relevant information is transmitted to the side of the apparatus by the information acquiring and transmitting section. On the side of the apparatus, the relative position of the apparatus to the remote controller can be recognized using the relevant information by the transmission, and an operation of a proper state can be performed based on the recognition.

According to a still further aspect of the present invention is provided a control system comprising a remote controller and an apparatus capable of being controlled by the remote controller,

wherein the remote controller comprises:

a housing formed separately from the apparatus;

an image pickup section provided in the housing and adapted to be capable of generating image information including information contributing to recognition of a relative position of the apparatus to the remote controller when imaging is performed toward the side of the apparatus;

an outer shape information holding section holding information related to the outer shape of one or more apparatus destined to be a control object;

a control object discriminating section discriminating an apparatus to be controlled based on correlation between image information acquired by the image pickup section and information held by the outer shape information holding section;

a relative position calculating section calculating a relative position of the apparatus to the remote controller using information related to an outer shape of an apparatus discriminated as an apparatus by the control object discriminating section and held by the outer shape information holding section and image information acquired by the image pickup section; and

an information transmitting section transmitting information representing the relative position of the apparatus to the remote controller calculated by the relative position calculating section to the apparatus, and

the apparatus comprises:

an information receiving section adapted to be capable of receiving information representing the relative position of the apparatus to the remote controller transmitted from the information transmitting section of the remote controller; and

an adjustment section performing a predetermined adjustment operation based on information received by the information receiving section.

It is an advantageous effect of at least some of the embodiments of the invention for an improved control system mentioned above that imaging is performed in an imaging field of view including the apparatus making use of the image pickup section provided on the remote controller side, the apparatus to be controlled is discriminated by comparison between image information acquired by the imaging and information related to the outer shape of one or more apparatus previously held by its own outer shape information holding section, the relative position of the apparatus to the remote controller is calculated using information of the outer shape or the like related to the apparatus appropriate to the result of the discrimination and image information acquired by the imaging, and information representing the calculated relative position of the apparatus to the remote controller is transmitted to the apparatus, whereby on the side of the apparatus receiving the transmitted information representing the relative position by the information receiving section, an adjustment operation of a state compatible with the relative position of the apparatus to the remote controller can be performed.

According to another aspect of the present invention is provided a remote controller adapted to be capable of performing predetermined control of an apparatus and formed separately from the apparatus, comprising:

an image pickup section provided in its own housing to be capable of generating image information including information contributing to recognition of a relative position of the apparatus to the remote controller when imaging is performed toward the side of the apparatus;

an outer shape information holding section holding information related to the outer shape of one or more apparatus destined to be a control object;

a control object discriminating section discriminating an apparatus to be controlled based on correlation between image information acquired by the image pickup section and information held by the outer shape information holding section;

a relative position calculating section calculating a relative position of the apparatus to the remote controller using information related to an outer shape of an apparatus discriminated as an apparatus by the control object discriminating section and held by the outer shape information holding section and image information acquired by the image pickup section; and

an information transmitting section transmitting information representing the relative position of the apparatus to the remote controller calculated by the relative position calculating section to the apparatus.

It is an advantageous effect of at least some of the embodiments of the invention for an improved remote controller mentioned above that imaging can be performed in an imaging field of view including the apparatus making use of its own image pickup section, the apparatus to be controlled can be discriminated by comparison between image information acquired by the imaging and information related to the outer shape of one or more apparatus previously held by its own outer shape information holding section, the relative position of the apparatus to the remote controller can be calculated using information of the outer shape related to the apparatus appropriate to the result of the discrimination and image information acquired by the imaging, and information representing the calculated relative position of the apparatus to the remote controller can be transmitted to the apparatus. As a result, on the side of the apparatus receiving the transmitted information representing the relative position by the information receiving section, an adjustment operation of a state compatible with the relative position of the apparatus to the remote controller can be performed.

According to a further aspect of the present invention is provided a control system comprising a remote controller and an apparatus capable of being controlled by the remote controller,

wherein the remote controller comprises:

a housing formed separately from the apparatus;

a relative position detecting section provided in the housing and detecting in a noncontact manner a relative change in the position of itself;

a current position calculating section calculating a current position of the remote controller in relation to a position of the apparatus based on a detection output of the relative position detecting section, and generating current position information representing the current position; and

an information transmitting section transmitting to outside the current position information generated by the current position calculating section, and

the apparatus comprises:

an information receiving section receiving the current position information transmitted from the information transmitting section of the remote controller; and

an operation mode selecting section selecting an operation mode based on the current position information received by the information receiving section.

It is an advantageous effect of at least some of the embodiments of the invention for an improved control system mentioned above that on the apparatus side, the position of the remote controller can be recognized in relation to the position of itself based on current position information transmitted from the remote controller side, and selection of an operation mode (selection of contents, adjustment of acoustic effects and the like in the case of an image and sound system) appropriate to a user of the control system (viewer in the case of an image and sound system) highly probably occupying the position can be performed according to the recognized position.

According to a still further aspect of the present invention is provided an apparatus configured to be capable of being controlled by a predetermined remote controller formed separately from the apparatus, comprising:

an information receiving section receiving current position information when the remote controller calculates a current position of the remote controller in relation to a position of the apparatus depending on a detection output of its own relative position detecting section and transmits position information representing the position to outside as current position information; and

an operation mode selecting section selecting an operation mode based on the current position information received by the information receiving section.

It is an advantageous effect of at least some of the embodiments of the invention for an improved apparatus mentioned above that the position of the remote controller can be recognized in relation to the position of itself based on current position information transmitted from the remote controller side, and selection of an operation mode (selection of contents, adjustment of acoustic effects and the like in the case of an image and sound system) appropriate to a user of the control system (viewer in the case of an image and sound system) highly probably occupying the position can be performed according to the recognized position.

According to another aspect of the present invention is provided a remote controller adapted to be capable of performing predetermined control of an apparatus and having a housing separate from the apparatus, comprising:

a relative position detecting section provided in the housing and detecting in a noncontact manner a relative change in the position of itself;

a current position calculating section calculating a current position of the remote controller in relation to a position of the apparatus based on a detection output of the relative position detecting section, and generating current position information representing the current position; and

an information transmitting section transmitting to outside the current position information generated by the current position calculating section.

It is an advantageous effect of at least some of the embodiments of the invention for an improved remote controller mentioned above that the current position of the remote controller is calculated in relation to the position of the apparatus based on a detection output of the relative position detecting section, and current position information representing the position is generated and supplied to the apparatus, and therefore on the side of the apparatus receiving the current position information, the position of the remote controller can be recognized in relation to the position of itself, and selection of an operation mode (selection of contents, adjustment of acoustic effects and the like in the case of an image and sound system) appropriate to a user of the control system (viewer in the case of an image and sound system) highly probably occupying the position can be performed according to the recognized position.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings.

FIG. 1 is a conceptual view showing a control system (liquid crystal television receiver system) as an embodiment of the present invention.

FIG. 2 is a block diagram showing a circuit configuration of a liquid crystal television in the control system of FIG. 1.

FIG. 3 is a block diagram showing a circuit configuration of a remote control in the control system of FIG. 1.

FIG. 4 is a conceptual view for explaining the principle of calculation of a relative position for use in an embodiment of the present invention.

FIG. 5 is a flowchart showing the outline of an operation of the control system (liquid crystal television system) as an embodiment of the present invention.

FIG. 6 is a schematic diagram showing a situation in which a position marker for use in a mark in calculation of a relative position of the remote control to the liquid crystal television is projected onto a display screen of an apparatus (liquid crystal television) in another embodiment of the present invention.

FIG. 7 is a conceptual view showing an embodiment in which a remote controller (remote control) operates in liaison with an external information processing apparatus through a communication section in a control system substantially same as the control system of FIG. 1 (and FIG. 14).

FIG. 8 is a flowchart showing the outline of the operation of the control system as an embodiment in which the communication section of the remote controller is used to make use of functions of the external information processing apparatus.

FIG. 9 is a flowchart showing the outline of the operation of the control system of still another embodiment in which the communication section of the remote controller is used to make use of functions of the external information processing apparatus.

FIG. 10 is a conceptual view showing an embodiment in which the present invention is applied to an automatic explanation apparatus in an aquarium.

FIG. 11 is a conceptual view for explaining an embodiment in which the present invention is applied to a remote operation system of an air conditioner.

FIG. 12 is a flowchart showing the outline of the remote operation system of the air conditioner of FIG. 11.

FIG. 13 is a flowchart showing the outline of the operation of the remote operation system of the air conditioner with a reduced burden on the remote controller side compared with that of FIG. 12.

FIG. 14 is a conceptual view showing the control system (liquid crystal television system) as an embodiment of the present invention.

FIG. 15 is a block diagram showing the circuit configuration of the liquid crystal television in the control system of FIG. 14.

FIG. 16 is a block diagram showing the circuit configuration of the remote control in the control system of FIG. 14.

FIG. 17 is a flowchart showing the outline of the operation of the control system as an embodiment of the present invention.

FIG. 18 is a flowchart showing the outline of the operation of the control system (liquid crystal television system) as another embodiment of the present invention.

FIG. 19 is a view explaining a method for automatically identifying a user traveling with a remote control in another embodiment of the present invention.

FIG. 20 is a flowchart showing the outline of the operation of the control system as still another embodiment of the present invention.

FIG. 21 is a flowchart showing the outline of the operation of the control system as still another embodiment of the present invention.

FIG. 22 is a conceptual view explaining a situation in which a user has a remote control as an embodiment of the present invention, and acts a specific behavior with respect to an apparatus destined to be a control object, whereby the remote control is made to recognize the apparatus.

FIG. 23 is a flowchart showing the operation of still another embodiment of the present invention.

FIG. 24 is a flowchart showing the outline of the control system (liquid crystal television system) as another embodiment of the present invention.

FIG. 25 is a flowchart showing the outline of the operation of the control system (liquid crystal television system) as still another embodiment of the present invention.

FIG. 26 is a flowchart showing the operation of still another embodiment of the present invention.

FIG. 27 is a conceptual view showing an embodiment in which the present invention is applied to an automatic explanation apparatus in an aquarium.

FIG. 28 is a flowchart showing the operation of still another embodiment of the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

For the description that follows, the general term “apparatus” is used to include the apparatus (for example, TV receiver or display panel device) subjected to control under the command of a remote controller. Embodiments of the present invention will be described below with reference to the drawings.

In the drawings to which a reference will be made below, main parts as subjects of explanations are exaggerated as appropriate and parts other than the main parts are simplified or omitted as appropriate for the sake of convenience.

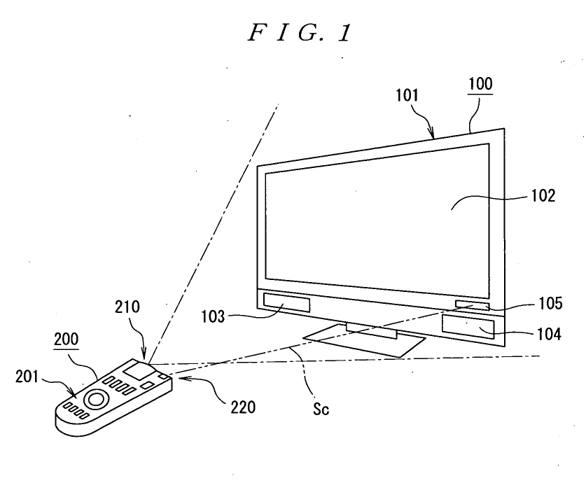

FIG. 1 is a conceptual view showing a control system (liquid crystal television receiver system) as an embodiment of the present invention comprising an apparatus (liquid crystal television receiver main body) and a remote controller (remote control corresponding to the liquid crystal television receiver main body). In FIG. 1, a liquid crystal television receiver main body (hereinafter referred to as liquid crystal television) 100 as an apparatus is configured to be capable of receiving a control signal by infrared light or the like from a remote controller 200 corresponding to the liquid crystal television receiver main body 100 to have its operation controlled.

The liquid crystal television 100 has in its housing 101 a screen 102 onto which an image is projected, a left speaker 103 and a right speaker 104 constituting a stereo type sound apparatus at a location lower than the bottom side of the screen 102, and a light receiving window 105 receiving a control signal Sc (shown by a tow-dot chain line) by infrared light or the like from the remote controller 200 just right below the bottom side of the screen 102.

The remote controller 200 has an independent housing 201 capable of being placed at a location distant from the liquid crystal television 100 (housing 101), and this housing 201 is provided with an image pickup section 210 adapted to be capable of generating image information including information contributing to recognition of a relative position of the liquid crystal television 100 (its housing 101) as the apparatus to its own housing 201 when imaging is performed toward the liquid crystal television 100 side (described later) and a control signal projecting portion 220 comprising a light emitting element such as an infrared LED emitting the control signal Sc by infrared light or the like to the liquid crystal television 100.

The control system (liquid crystal television system) 100+200 of the present invention is configured to include the above mentioned liquid crystal television 100 and remote controller 200. The control signal Sc includes a signal representing image information described later in addition to a signal representing information itself for controlling the liquid crystal television 100 according to any operation by an operator.

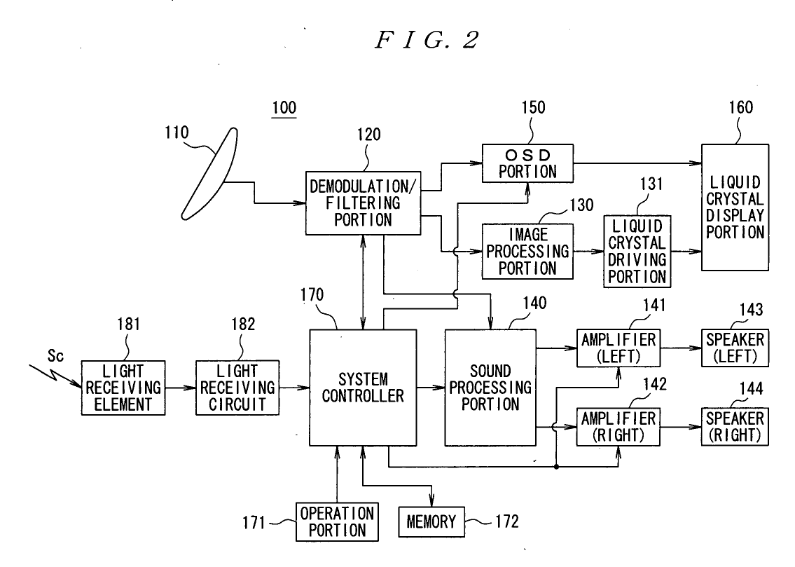

FIG. 2 is a block diagram showing the circuit configuration of the liquid crystal television 100 of FIG. 1. A broadcast wave received by an antenna 110 is demodulated by a demodulation/filtering portion 120, a transport stream is extracted, and filtering for acquiring images and sounds and program information of a channel selected by a viewer (user) is performed. An image output of the demodulation/filtering portion 120 is supplied to an image processing portion 130, a sound output is supplied to a sound processing portion 140, and program information is supplied to an OSD portion 150.

An image is projected onto a liquid crystal display device 160 via a liquid crystal driving portion 131 by the output of the image processing portion 130. Program information and other information is displayed on a screen of the liquid crystal display device 160 in such a manner that it is superimposed on the above-mentioned image or it occupies an area in the screen based on the output of the OSD portion 150. The output of the sound processing portion 140 is supplied via left and right amplifiers 141 and 142 to corresponding left and right speakers 143 and 144 to produce stereo sounds.

A system controller 170 providing supervisory control for the entire system of the liquid crystal television 100 including the above-mentioned demodulation/filtering portion 120, sound processing portion 140 and OSD portion 150 is provided. The system controller 170 is adapted to be supplied with an output of an operation portion 171 comprising an operation key accepting an operation by a viewer (user), and the like, and a memory 172 is accessibly connected thereto so that data (information) is stored and read in required timing.

Connection is established so that the output of a light receiving element 181 provided behind the light receiving window 105 described with reference to FIG. 1 so as to receive the control signal Sc is supplied to the system controller 170 via a light receiving circuit 182 comprising a signal amplification circuit and the like. The described left and right amplifiers 141 and 142 are supplied with control signals from the system controller 170 to adjust an amplification factor, whereby a balance adjustment of stereo sounds is made, but in this example, as described in detail later, this balance adjustment can be appropriately made in accordance with the location (position/direction) of the remote control (viewer having the remote controller).

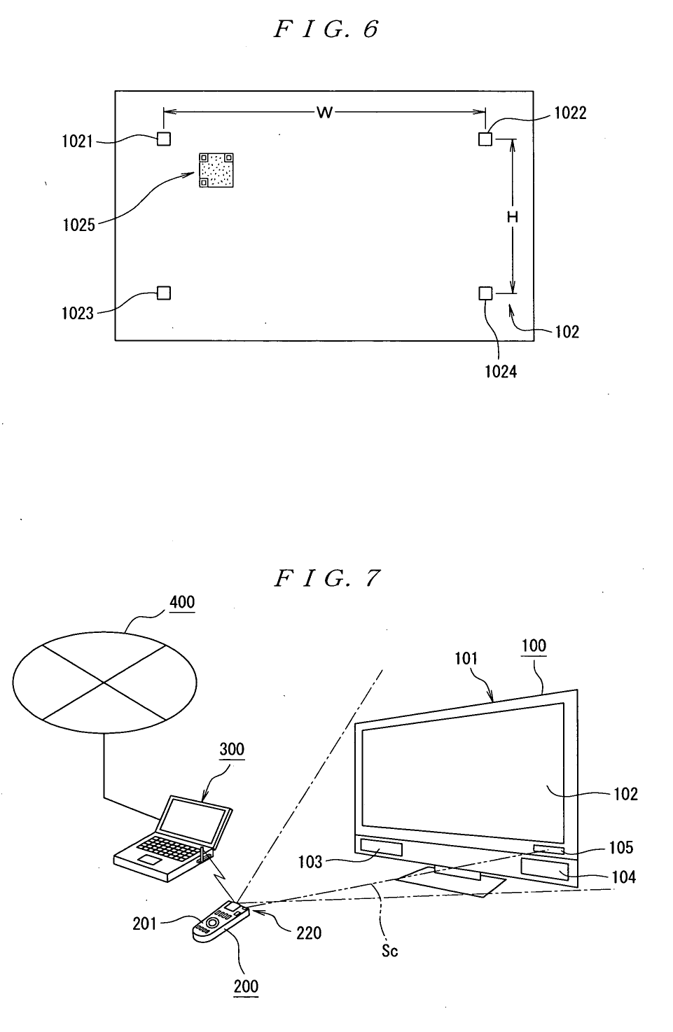

In the above description, a position marker detecting section including a relevant functional portion of the system controller 170 providing supervisory control for the entire system of the liquid crystal television 100 and the OSD portion 150 and projecting onto the screen 102 position markers 1021, 1022, 1023 and 1024 described later in detail with reference to FIG. 6, and a coded information pattern projecting section projecting onto the screen 102 a coded information pattern 1025, an example of which is a two-dimensional bar code such as a QR codes are formed.

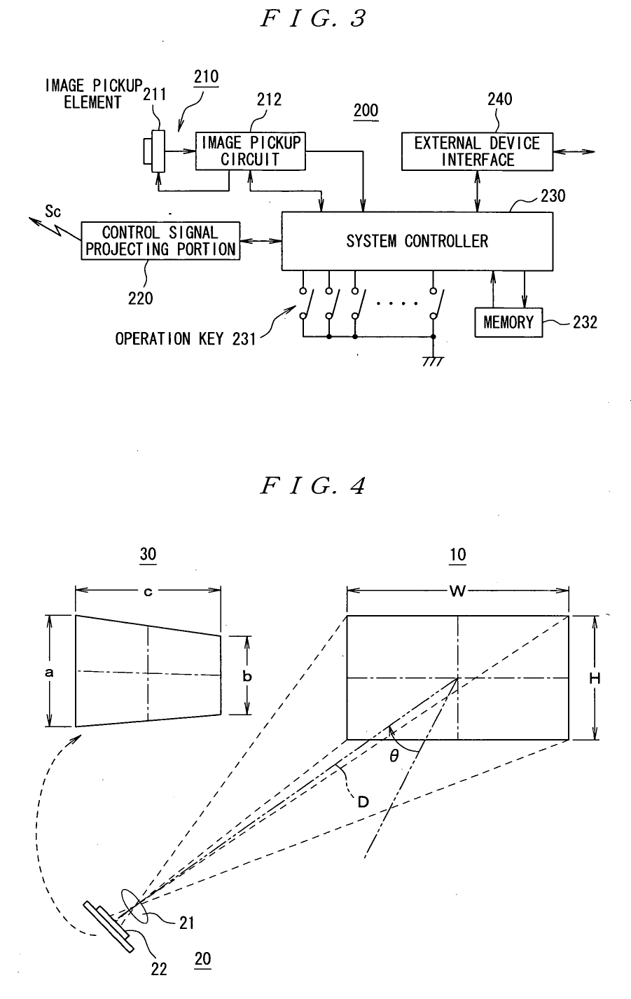

FIG. 3 is a block diagram showing the circuit configuration of the remote controller 200. The control signal projecting portion 220 comprising a light emitting element such as an infrared LED emitting the control signal Sc by infrared light or the like, which has been described with reference to FIG. 1, is connected to a system controller 230 providing supervisory control for the circuit system of the remote controller 200 and including as a main component a micro processor performing various operations, and emits a required control signal Sc according to a command from the system controller 230.

An image pickup element 211 and an image pickup circuit 212 as the image pickup section 210 described with reference to FIG. 1 are provided. This image pickup circuit 212 drives the image pickup element 211 to perform imaging under the system controller 230, reads an image signal acquired by the imaging, subjects the image signal to required signal conversion, and supplies image data thus generated to the system controller 230.

An operation signal from an operation key 231 for performing a channel switching operation and the like, provided in the housing 201 of the remote controller 200, is input to the system controller 230, and an access can be made to a memory 232 to give and receive data. Further, an external device interface 240 for communicating with an external information processing apparatus such as a personal computer is connected to the system controller 230.

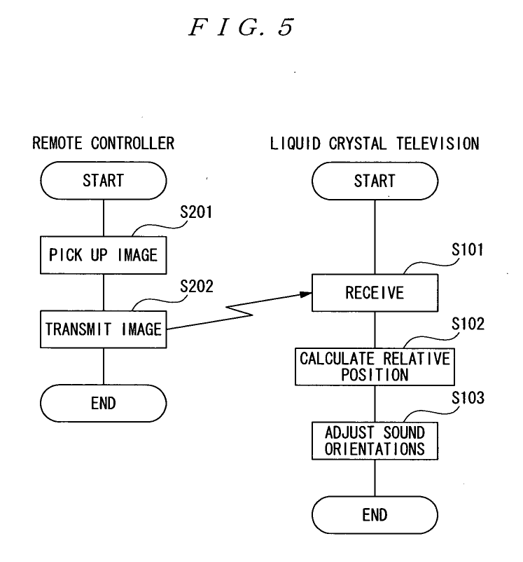

FIG. 4 is a conceptual view for explaining the principle of calculation of a relative position for use in the embodiment of the present invention in which a subject having a known shape and size, such as, for example, a screen of a square television receiver or a housing outside thereof, is imaged by an image pickup section (camera), and a relative position of the subject to the camera is determined from a state of an image acquired by the imaging. In FIG. 4, it is assumed that a screen 10 of a television receiver as a known subject is imaged by a camera 20, and an image 30 represented by image data is generated by the imaging.

The horizontal dimension of the screen 10 of the television receiver is W, the vertical dimension is H, and these dimensions are known. This screen 10 is imaged on an image pickup surface 22 of the image pickup element by a lens 21 of the camera 20, and the image 30 represented by image data is obtained as an output subjected to photoelectric conversion. If the position of the camera 20 is opposite to the center of the screen 10 of the television receiver being a subject, the shape of the image 30 is geometrically similar to that of the actual screen 10, but the position is deviated from an opposite position like this, the shape of the image 30 as a result of being imaged is distorted in a trapezoidal form, and so called a trapezoidal distortion occurs.

Now, the horizontal dimension of the screen 10 as a subject is W, the vertical dimension is H, and these dimensions are known, and for the trapezoidal image by the trapezoidal distortion of the image being image information (image 30 represented by image data) acquired by imaging by the camera 20, the dimension of the longer side is a, the dimension of the shorter side is b, and the dimension of the height is c. The distance D between the camera 20 and the screen 10 as a subject is determined from an imaging magnification (focus distance of lens 21) and a dimensional relation between corresponding parts such as a relation between W and c described above, or easily determined by a well known method of active AF based on the principle of triangle distance measurement which is often used in a compact camera and the like.

Thus, from the relation of data representing the horizontal dimension w of the screen 10, the vertical dimension H, the height c of the trapezoidal image, the longer side a, the shorter side b and the distance D described above, a degree of deviation from the position (normal line direction) in which the camera is opposite to the center of the screen 10 as a subject is an angle θ. That is, if the data described above is prepared, a relative position of the apparatus (television receiver) to the remote controller (remote control) can be calculated based on these data.

If the relative position of the apparatus (television receiver) to the remote controller (remote control) is calculated based on the above-mentioned principle in a practical apparatus, data showing a relation of values which can be taken in a practical range for the above values W, H, c, a, b and D is integrated into a lookup table. In the case of an embodiment in which the above-mentioned relative position is calculated in the television receiver 100, a lookup table holding such data is stored in the memory 172 in the configuration of FIG. 2, and the system controller 170 makes a reference to this lookup table in timing as required to calculate the angle θ.

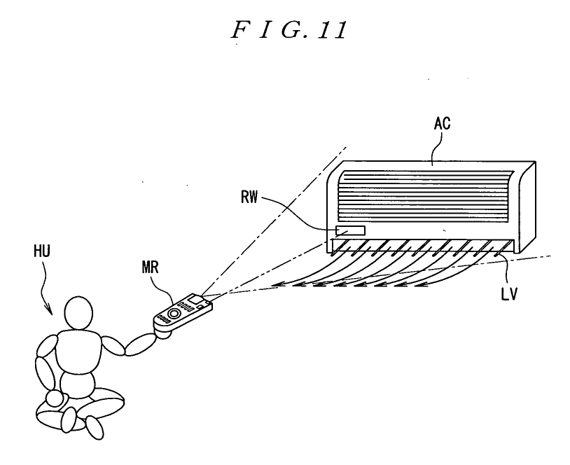

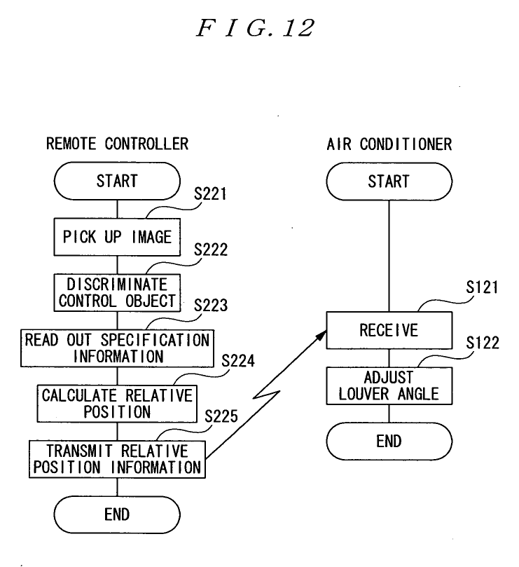

If the above-mentioned relative position is calculated on the remote controller 200 side as in an embodiment described later with reference to FIGS. 11 and 12, similarly, a lookup table holding such data is stored in a memory 232 in the configuration in FIG. 3, and the system controller 230 makes a reference to this lookup table in timing as required to calculate the angle θ. In this case, the above-mentioned relative position is calculated on the remote controller 200 side, and therefore the television receiver 100 can receive information of the relative position as a result of calculation and perform an adaptive adjustment operation.

Instead of the method in which the relative position of the apparatus (television receiver) to the remote controller (remote control) is calculated by making a reference to the lookup table previously prepared in the memory, a method in which a trapezoidal distortion operating section performing an operation for determining a trapezoidal distortion using information contributing to recognition of the relative position of the apparatus to the remote controller in image information received by the information receiving section on the apparatus side (for example, marker information representing specific position markers placed at positions corresponding to four corners of a square having a known size, etc.) is formed by, for example, a relevant functional portion of the system controller, and the relative position of the apparatus to the remote controller is calculated using the result of the operation by the trapezoidal distortion operating section and information related to the outer dimension of the apparatus previously prepared to be available may be applied.

FIG. 5 is a flowchart showing the outline of an operation of the control system (liquid crystal television system) 100+200 as an embodiment of the present invention comprising the liquid crystal television 100 and the remote controller 200 described above. The embodiment of the present invention will be further described in detail below with reference to the flowchart and the described drawings as appropriate. The flowchart of FIG. 5 is abstracted so that it is applicable in common for a plurality of ways of alterations.

In FIG. 5, first, on the side of the remote controller 200 having the configuration of FIG. 3, imaging is performed by the image pickup section 210 (image pickup element 211+image pickup circuit 212) (S201) after the operation is started. Then, image data acquired at S201 is converted into the control signal Sc by infrared light or the like, projected and thereby transmitted by the system controller 230 (its relevant functional portion) and the control signal projecting portion 220 (S202), and the projected signal Sc is received by the light receiving element 181 of the liquid crystal television 100 of FIG. 2, subjected to predetermined signal conversion via the light receiving circuit 182, and supplied to the system controller 170 (S101). An information receiving section is constituted by the light receiving element 181, the light receiving circuit 182 and the system controller 170 (its relevant functional portion)

Then, in the system controller 170 as the relative position calculating section of the liquid crystal television 100, processing compliant with the principle described with reference to FIG. 4 is performed using information representing the received image (image data corresponding to the signal Sc) to calculate the relative position of the liquid crystal television 100 as the apparatus to the remote controller 200 (S102). On the liquid crystal television 100 side (FIG. 2), according to the relative position of itself 100 to the remote controller 200 thus calculated, a command is issued from the system controller 170, the amplification factors of left and right amplifiers 141 and 142 are adjusted to adjust sound volumes of left and right speakers 143 and 144, whereby sound orientations are adjusted (S103) so that looking and listening can be optimum at a location of the remote controller 200 (it is estimated that the viewer is situated near this location), and a series of operations is completed.

According to the above-mentioned control system, imaging is performed in an imaging field of view including the apparatus (liquid crystal television 100) making use of the image pickup section provided on the remote control (remote controller 200) side, and image information acquired by the imaging is transmitted to the apparatus, whereby on the side of the apparatus receiving the transmitted image information by the information receiving section, the relative position of the remote controller to the apparatus can be calculated. On the side of the apparatus recognizing the calculated position of the remote controller, an operation of an aspect compatible with the recognition can be performed.

Here, the operation of an aspect compatible with the recognition after the recognition of the position of the remote controller means, for example, sound volume balance adjustment in which sound orientations of left and right speakers 143 and 144 are adjusted to be along the direction of the remote controller 200 (hence, a viewer having the remote controller 200 or situated at a position near the remote controller 200), and an operation of preferentially selecting contents compatible with a specific viewer highly probably situated at the position (e.g. the master of a family in the case of the position on the side of the screen of the liquid crystal television 100, the wife in the case of the position opposite to the center, a child in the case of the intermediate position, etc.) and projecting the same, or the like.

In one alteration in the embodiment described with reference to the flowchart of FIG. 5, on the remote controller 200 side, information related to the outer shape of one or more apparatus destined to be the apparatus is held in the memory 232 functioning as an outer shape information holding section, and by the system controller 230 configured to function also as a control object discriminating section, the apparatus to be controlled is discriminated based on correlation between image information imaged by the image pickup section and information related to the outer shape of the apparatus held in the memory 232.

If such an arrangement is made on the remote controller 200 side, the remote controller 200 itself discriminates the apparatus to be controlled by its own control object discriminating section, and therefore a code system of a control command and specifications compatible with the discriminated apparatus can be recognized to perform precise control. More specifically, for example, in transmission of image information at step S202, image data acquired at S201 can be converted into the control signal Sc by infrared light or the like compatible with the above-mentioned code system and projected onto the liquid crystal television 100, thus making it possible to use one remote controller 200 in common for a plurality of apparatuses having different code systems of the control demand.

In the above-mentioned alteration, images acquired by previously performing imaging by an appropriate image pickup section and related to the outer shape of one or more apparatus destined to be the apparatus may be held in the memory 232 on the remote controller 200 side. In this way, when the remote controller 200 discriminates the apparatus to be controlled by its own control object discriminating section (system controller 230), the image related to the outer shape of the apparatus itself destined to be a control object can be made available as a reference for the discrimination, and the control object is precisely discriminated.

FIG. 6 is a schematic diagram showing a situation in which a position marker for use in a mark in calculation of a relative position of the remote controller 200 to the liquid crystal television 100 based on the trapezoidal distortion described with reference to FIG. 4 is projected onto the display screen (screen 102) of the liquid crystal television 100 as the apparatus in another embodiment. In the example of FIG. 6, four position markers 1021, 1022, 1023 and 1024 having a mutual horizontal distance of W and a mutual vertical distance of H are projected in the screen 102.

In the system in position markers are projected as in FIG. 6, the horizontal distance W and the vertical distance H related to the marker information can be used as the known values W and H described with reference to FIG. 4 to calculate a relative position of the apparatus (liquid crystal television 100) to the remote controller (remote controller 200). Usually, such an image like a bright point having a simple shape is easily extracted as a unique pattern from picked-up images, and the precisely extracted information can be applied to determine the previously described relative position based on the trapezoidal distortion operation in the system controller 230 functioning as the trapezoidal distortion operating section.

In the embodiment of FIG. 6, the above-mentioned four position markers 1021, 1022, 1023 and 1024 of the apparatus (liquid crystal television 100) are projected, but in addition thereto, a coded information pattern 1025 recognizable on the remote controller (remote controller 200) side is projected. This coded information pattern 1025 is, for example, a two-dimensional bar code such as QR code®.

Such a coded information pattern 1025 is projected on the apparatus side, and information of, for example, horizontal and vertical intervals among four position markers 1021, 1022, 1023 and 1024 and specifications of the apparatus itself (code system of the compatible control command) is represented by the coded information pattern 1025, whereby on the remote controller (remote controller 200) side, information contributing to recognition of the relative position of the apparatus (liquid crystal television 100) to the remote controller (remote controller 200) can be easily and reliably acquired if imaging is performed in an imaging field of view including these position markers 1021, 1022, 1023 and 1024 and the coded information pattern 1025.

FIG. 7 is a conceptual view of an embodiment in which the remote controller (remote controller 200) operates in liaison with an external information processing apparatus through a communication section (external device interface 240 previously described with reference to FIG. 3) in a control system substantially same as the control system (liquid crystal television system) 100+200 described with reference to FIG. 1. In FIG. 7, parts corresponding to those of FIG. 1 described previously are given same symbols.

The liquid crystal television 100 is configured to be capable of receiving a control signal by infrared light or the like from the remote controller 200 corresponding to the television to have its operation controlled. The liquid crystal television 100 has in its housing 101 the screen 102 onto which an image is projected, the left speaker 103 and the right speaker 104 constituting a stereo type sound apparatus at a location lower than the bottom side of the screen 102, and the light receiving window 105 receiving a control signal Sc (shown by a tow-dot chain line) by infrared light or the like from the remote controller 200 just right below the bottom side of the screen 102.

The remote controller 200 has the independent housing 201 capable of being placed at a location distant from the liquid crystal television 100 (its housing 101), and this housing 201 is provided with the image pickup section 210 adapted to be capable of generating image information including information contributing to recognition of a relative position of the liquid crystal television 100 (its housing 101) as the apparatus to its own housing 201 when imaging is performed toward the liquid crystal television 100 side and the control signal projecting portion 220 comprising a light emitting element such as an infrared LED emitting the control signal Sc by infrared light or the like to the liquid crystal television 100.

The control system (liquid crystal television system) 100+200 of the present invention is configured to include the above mentioned liquid crystal television 100 and remote controller 200. This embodiment is similar to the embodiment described with reference to FIG. 1 in that the control signal Sc includes a signal representing image information described later in addition to a signal representing information itself for controlling the liquid crystal television 100 according to any operation by an operator.

As described previously with reference to FIG. 3, the remote controller 200 further comprises the external device interface 240 as the communication section communicating with a personal computer (hereinafter referred to as PC) 300 as an external information processing apparatus. More strictly, the communication section is configured to include relevant functional portions and the like of the external device interface 240 and the system controller 230 to which the external device interface 240 is connected. The PC 300 is further connected to an internet 400, and therefore various data can be acquired through the internet 400 and made use of in addition to data held by itself.

According to the control system of FIG. 7, a higher level of control can be performed with a simple configuration without considerably increasing a burden on the remote controller itself by making use of functions of the external information processing apparatus through the communication section in addition to the action by the control system of FIG. 1.

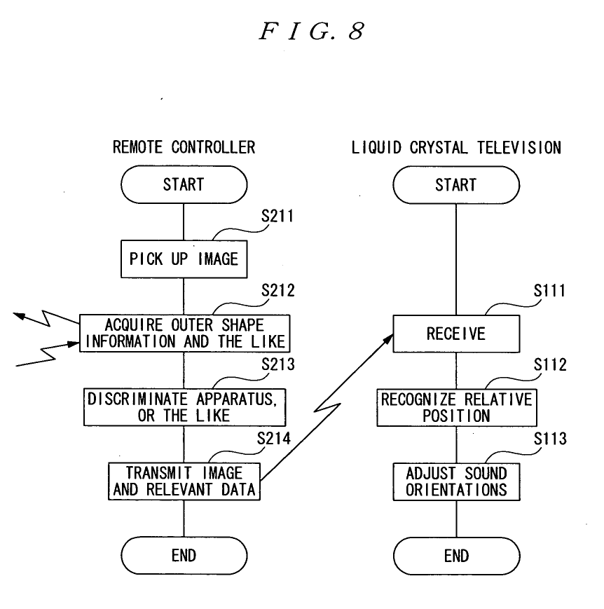

FIG. 8 is a flowchart showing the outline of an operation of the control system (liquid crystal television system) 100+200 as an embodiment in which the communication section of the remote controller is used to make use of functions of the external information processing apparatus. The embodiment of the present invention will be described further in detail below with reference to the flowchart and the previously described drawings as appropriate. The flowchart of FIG. 8 is also abstracted so that it is applicable in common for a plurality of ways of alterations.

In FIG. 8, first, on the side of the remote controller 200 having the configuration of FIG. 3, imaging is performed by the image pickup section 210 (image pickup element 211+image pickup circuit 212) (S211) after the operation is started. Then, information related to the outer shape of one or more apparatus destined to be the apparatus is acquired through the communication section (240+relevant functional portion of 230) by the relevant function of the system controller 230 as an outer shape information acquiring section (S212).

Further, the system controller 230 as the control object discriminating section discriminates the apparatus to be controlled based on correlation between the image of the control object in an image including in an imaging field of view the control object previously acquired by the image pickup section 210 at step S211 and information related to the outer shape of the apparatus acquired at step S212 (S213). When the apparatus is discriminated at step S213, the code system of a control demand and specifications compatible with the apparatus can be recognized to perform precise control on the remote controller (remote controller 200) side.

The remote controller 200 transmits the image acquired at S211 and including the control object in the imaging field of view to the liquid crystal television 100 as a control object using a code of an aspect compliant with the code system of a control command compatible with the above-mentioned apparatus (S214). On the liquid crystal television 100 side, image information transmitted in this way is received (S111), a relative position of the remote controller 200 to the liquid crystal television 100 is calculated in a manner described previously (S112), the amplification factors of left and right amplifiers 141 and 142 are adjusted to adjust sound volumes of left and right speakers 143 and 144, whereby sound orientations are adjusted (S113) so that looking and listening can be optimum according to the relative position, and a series of operations is completed.

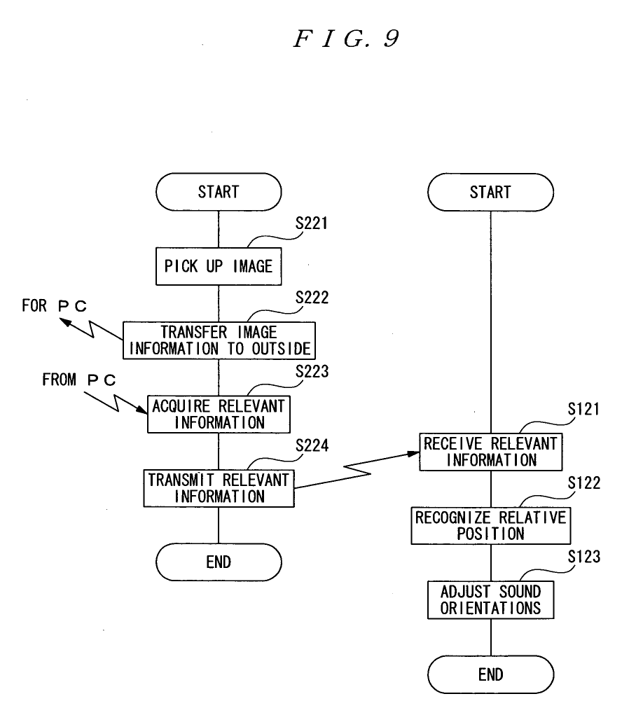

FIG. 9 is a flowchart showing the outline of an operation of the control system (liquid crystal television system) 100+200 of still another embodiment in which the communication section of the remote controller is used to make use of functions of the external information processing apparatus. The embodiment of the present invention will be described further in detail below with reference to the flowchart and the previously described drawings as appropriate. The flowchart of FIG. 9 is also abstracted so that it is applicable in common for a plurality of ways of alterations.

In FIG. 9, first, on the side of the remote controller 200 having the configuration of FIG. 3, imaging is performed by the image pickup section 210 (image pickup element 211+image pickup circuit 212) (S221) after the operation is started. Then, image data by imaging acquired at step S221 is transferred to the PC 300 as the external information processing apparatus through the communication section (240+relevant functional portion of 230) (S222).

On the PC 300 side, when image data transferred at step S222 is received, then the image data, and data, operational algorisms and the like prepared by acquisition through the internet 300 as required and so on are used as appropriate to prepare specifications and other data of the apparatus associated with the image data, and the data is sent back to the remote controller 200 as associated information, and on the remote controller 200 side, this associated information is acquired through the communication section (240+relevant functional portion of 230) (S223). The remote controller 200 transmits the associated information acquired at step S223 to the liquid crystal television 100 as the apparatus (S224).

In the above description, the function of transferring image data acquired by imaging to the PC 300 side at step S222, acquiring associated information of the image data supplied with a response from the PC 300 side through the communication section at step S223, and transmitting the acquired associated information to the liquid crystal television 100 side at step S224 is provided by the system controller 230 as an information acquiring and transmitting section and associated functional portions.

On the liquid crystal television 100 side, associated information transmitted to itself at step S224 is received (S121), a relative position of the apparatus (liquid crystal television 100) to the remote controller (remote controller 200) is recognized by the system controller 170 as a relative position recognizing section based on the received associated information (S122), the amplification factors of left and right amplifiers 141 and 142 are adjusted according to the recognition to adjust the sound volumes of left and right speakers 143 and 144, whereby the orientations of sounds are adjusted (S123), and a series of operations is completed.

In the embodiment described with reference to FIG. 9, image information related to the apparatus (liquid crystal television 100), acquired by imaging in the remote controller (remote controller 200), is supplied to the external information processing apparatus (PC 300) through the communication section, and a high information acquirement processing capability by the PC 300 is used, whereby associated information of sufficient contents related to the liquid crystal television 100 can be acquired and transmitted to the liquid crystal television 100 by the information acquiring and transmitting section without excessively increasing a burden on the remote controller 200 side.

On the apparatus (liquid crystal television 100) side, a relative position of the apparatus (liquid crystal television 100) to the remote controller (remote controller 200) can be recognized using the associated information by the transmission, and an operation of a precise aspect can be performed based on the recognition. For example, by using the high information acquirement processing capability of the external information processing apparatus (PC 300), even information representing a relative position of the apparatus (liquid crystal television 100) to the remote controller (remote controller 200) can be acquired as the above-mentioned associated information in the information processing apparatus.

In this way, the configuration on the apparatus (liquid crystal television 100) side can be a configuration in which a relative position of the apparatus (liquid crystal television 100) to the remote controller (remote controller 200) is recognized depending on information representing a relative position as associated information already determined without waiting for an operation in a different stage, and the amplification factors of left and right amplifiers 141 and 142 according to the recognition to adjust the sound volumes of left and right speakers 143 and 144, whereby the orientations of sounds are adjusted, thus making it possible to simplify the configuration on the apparatus (liquid crystal television 100) side.

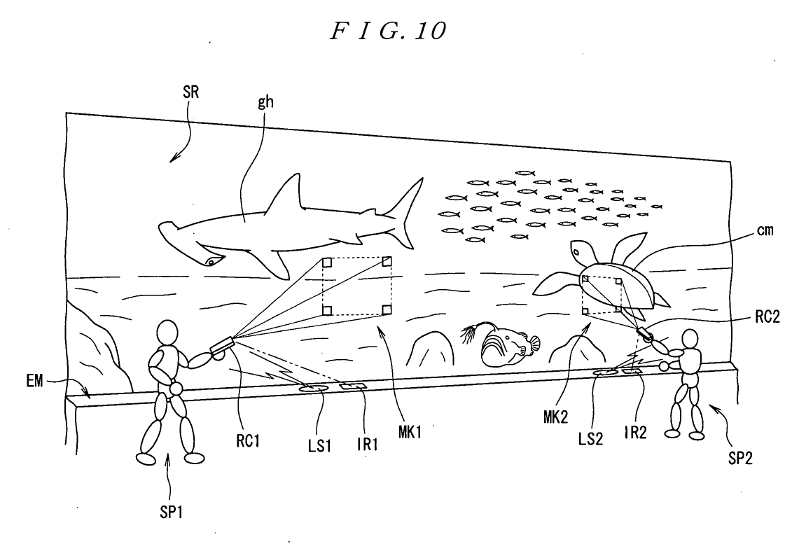

FIG. 10 is a conceptual view showing an embodiment in which the present invention is applied to an automatic explanation apparatus in an aquarium. The example shown in the figure is a system in which explanations by sounds are automatically broadcasted in appropriate timing for living organisms in a panoramic giant migration aquarium. At intermediate standard positions in a transparent screen SR made from an acryl thick plate, a plurality of sets of marker groups MK1, MK2, . . . with four pieces as one set as described previously with FIG. 4 are attached or projected by an appropriate optical section at predetermined intervals.

An appliance housing portion EM shielding cables, electric circuits and other appliances is formed in such a manner as to protrude by forming steps on the front side zonally along the lower side of a screen SR, and a shoulder of the appliance housing portion EM is provided with infrared signal light receiving portions IR1, IR2, . . . at intervals in such a manner as to substantially correspond to a plurality of sets of marker groups MK1, MK2, . . . , and further provided with speakers LS1, LS2, . . . giving off sounds for explanations such that they are adjacent to the infrared signal light receiving portions IR1, IR2, . . . , respectively.

Spectators SP1, SP2, . . . have remote controls RC1, RC2 . . . each comprising an image pickup section having a configuration substantially same as that of FIG. 3. If the marker groups MK1, MK2, . . . are imaged by the image pickup sections of the remote controls RC1, RC2 . . . , image data of the makers MK1, MK2, . . . by the imaging is automatically transmitted to the infrared signal light receiving portions IR1, IR2, . . . by signals by infrared light, and positions of corresponding remote controls RC1, RC2 . . . , and hence the spectators SP1, SP2, . . . are determined in a manner same as that described with reference to FIG. 4 by appliances provided in the appliance housing portion EM.

When positions of the spectators SP1, SP2, . . . are determined, explanations for a living organism within the field of view of spectators or coming into the field of view of spectators are broadcasted toward the spectators SP1, SP2, . . . from the speakers LS1, LS2, . . . placed near the positions of the spectators SP1, SP2, . . . , respectively. Namely, a position of a living organism in the aquarium to be explained is determined by, for example, detecting in the passive sonar principle a signal generated by an ultrasonic wave tag attached to each individual, and a living organism in the field of view of spectators is determined according to the positions determined based on signals from the remote controls RC1, RC2 . . . , and relevant explanations are broadcasted from the speakers LS1, LS2, . . . .

If the spectator SP1 situated on the left side of the screen SR images the marker group MK1 by the image pickup section using the remote control RC1 as shown in the figure, its position is determined in the manner described above, and from the speaker LS1 situated at a position nearest to the spectator SP1, explanations like “it is great hammerhed shark that is now swimming across in front of the customer having remote control No. 1”., “it is fish of Carcharhiniformes, Sphyrnidae, and inhabits in temperate or tropical sea in the world. Some individuals grow to the length of 6 meters, and the fish is one of the largest of Sphyrnidae. . . . ” are broadcasted in directivity from the speaker LS1 toward the spectator SP1 for great hammerhed shark gh just swimming across the field of view of the spectator SP1.

Similarly, for the spectator SP2 situated to the right of the screen SR and looking at a green turtle cm just before his or her eyes, explanations like “it is a green turtle that is now in front of the customer having remote control No. 2.”, “the green turtle is a reptile of Chelonia, Cheloniidae, and inhabits in tropical or temperate sea, and also in Mediterranean sea, and some have a shell length of 80 centimeters to 1 meter or greater . . . . ” are broadcasted in directivity from the speaker LS2 to the spectator SP2. Even if explanations described above are broadcasted from the speakers LS1 and LS2 at the same time, the spectators SP1 and SP2 can listen and look without much concern for interferences because explanations for the object give attention by each spectator are broadcasted in directivity compatible with each spectator.

What has been described above is an example in which the present invention is applied to a panoramic large aquarium, but for a relatively small aquarium in which a limited number of kinds of living organisms are subdivided, fed and presented on exhibition, a comfortable automatic explanation system producing sounds which are very easily listened to even under a somewhat dark and noisy situation if explanations compatible with the field of view of the spectator are broadcasted in optimum or adaptive directivity according to the position of the spectator.

In the above embodiment in which the present invention is applied to an aquarium, explanations may be displayed on a display provided in the remote control in some cases. In a small aquarium in particular, the extent within which living organisms to be explained travel is limited, and therefore an appliance in which a signal of an ultrasonic wave tag attached to each living organism is caught by a passive sonar as in a large aquarium may be omitted.

FIG. 11 is a conceptual view for explaining an embodiment in which the present invention is applied to a remote operation system of an air conditioner (hereinafter referred to air con). The example shown in the figure shows a case where an air con AC is remotely operated using a remote control MR capable of adaptively coping with various control objects. The remote control MR held by a user HU by hand comprises an image pickup section substantially as with the remote control described with reference to FIG. 3. The user HU remotely operates the air con AC with this remote control MR, but the automatic adjustment described below is carried out in addition to any manual operation.

FIG. 12 is a flowchart showing the outline of an operation of a remote operation system of the air con of FIG. 11. In FIG. 12, first, on the side of the remote control MR having the configuration of FIG. 3, the air con AC (its indoor machine, but hereinafter referred to as air con AC) is imaged by the image pickup section of the remote control MR with the air con AC in the field of view (S221) after the operation is started. Then, discrimination of the apparatus is performed based on correlation between the outer shape of one or more apparatus held in the memory 232 as the outer shape holding section and destined to be a control object and the image of the air con AC in the picked-up image (S222).

When the apparatus is specified at step S222, then data (specification information) such as the shape and dimension of the air con AC matching its type and the code system of control signals is read from the memory 232 as a specification information holding section (S223). Then, by a relevant function of the system controller 230 as the relative position calculating section, a relative position of the remote control MR to the air con AC is calculated based on the principle described with reference to FIG. 4 (S224).

The remote control MR transmits relative position information representing a relative position of the remote control MR to the air con AC calculated at step S224 to the air con AC as a control object using a code of an aspect compliant with a code system of a control command compatible with the air con AC, acquired at step S223 (S224). On the air con AC side, image information transmitted in this way is received (S121).

The air con AC adjusts the angle of a wind direction adjusting louver LV provided at an air outlet letting off temperature-adjusted air based on relative position information representing a relative position of the remote control MR to the air con AC received at step S121 (S122) and completes a series of operations related to wind direction automatic adjustment. The air con AC receives at a light receiving window RW a command of infrared light from the remote control MR to perform an appropriate operation for carrying out wind direction adjustment and temperature adjustment also in a manual mode by mode switching in addition to the function of automatically carrying out wind direction adjustment as described above.

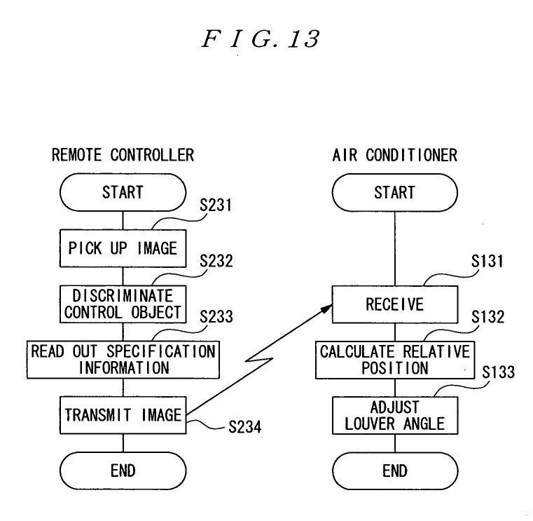

FIG. 13 is a flowchart showing the outline of an operation of the remote operation system in which a burden on the remote controller side is relieved compared to the system of FIG. 12. In FIG. 13, first, on the side of the remote control MR having a configuration similar to that of FIG. 3, imaging is performed with the air con AC in the imaging field of view (S231) after the operation is started. Then, discrimination for specifying the apparatus is performed based on correlation between the outer shape of one or more apparatus held in the memory 232 as the outer shape holding section and destined to be a control object and the image of the air con AC in the picked-up image (S232).

When the apparatus is specified at step S232, then data (specification information) such as the shape and dimension of the air con AC matching its type and the code system of control signals is read from the memory 232 as a specification information holding section (S233). By the system controller 230 (its relevant functional portion) and the control signal projecting portion 220 as the information transmitting section, image information acquired at step S231 is converted into the control signal Sc by infrared light or the like conforming to specification information recognized at step S233, and projected, whereby image information is transmitted (S234).

This projected signal Sc is received at the light receiving window RW of the air con AC (S131), and a relative position of the remote control MR to the air con AC is calculated in accordance with the principle described with reference to FIG. 4, by the relevant functional portion and memory portion (lookup table described previously) in the system controller or the like as the relative position calculating section on the air con AC side, based on the image information received in this way (S132).

Based on relative position information representing the relative position of the remote control MR to the air con AC calculated at step S132, the air con AC responsively operates an internal wind direction adjusting servo mechanism to adjust the angle of the wind direction adjusting louver LV provided at the air outlet letting off temperature-controlled air (S133) so that the wind direction points to the user HU, and a series of operations related to wind direction automatic adjustment is completed.

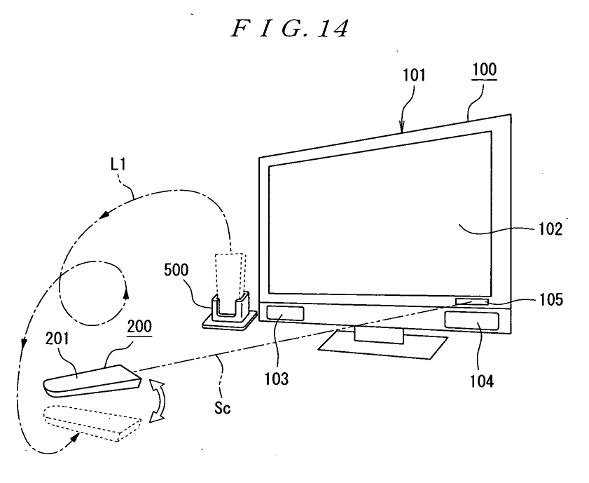

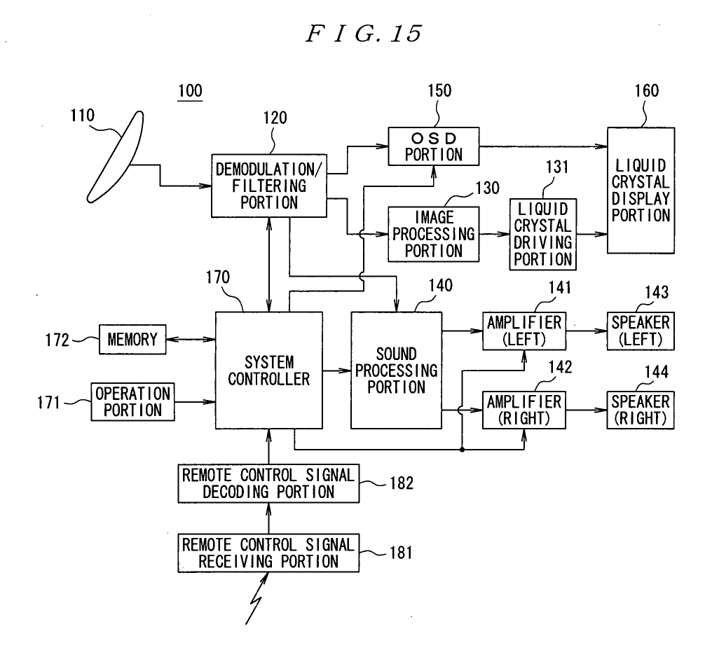

FIG. 14 is a conceptual view showing the control system (liquid crystal image receiver system) as another embodiment of the present invention comprising the apparatus (liquid crystal television receiver main body) and the remote controller (remote control corresponding to the liquid crystal television receiver main body). In FIG. 14, the liquid crystal television receiver main body (hereinafter referred to as liquid crystal television) 100 as the apparatus is configured to be capable of receiving a control signal by infrared light or the like from the remote controller 200 corresponding to the liquid crystal television receiver main body 100 to have its operation controlled.

The liquid crystal television 100 has in its housing 101 the screen 102 onto which an image is projected, the left speaker 103 and the right speaker 104 constituting a stereo type sound apparatus at a location lower than the bottom side of the screen 102, and the light receiving window 105 receiving a control signal Sc (shown by a tow-dot chain line) by infrared light or the like from the remote controller 200 just right below the bottom side of the screen 102.

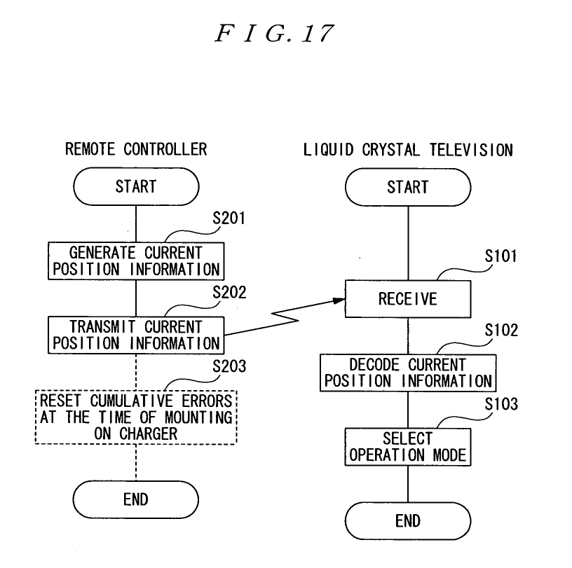

The remote controller 200 has the independent housing 201 capable of being placed at a location distant from the liquid crystal television 100 (its housing 101), and this housing 201 is provided therein with the relative position detecting section detecting a relative change in the position of itself and the control signal projecting portion 220 comprising a light emitting element such as an infrared LED emitting the control signal Sc by infrared light or the like to the liquid crystal television 100 (FIG. 16).

The control system (liquid crystal television system) 100+200 of the present invention is configured to include the liquid crystal television 100 and the remote controller 200 described above. The control signal Sc by infrared light or the like includes a signal representing information for performing communication between the liquid crystal television 100 and the remote controller 200 in addition to the control signal representing information itself for controlling the liquid crystal television 100 according to any operation by the operator.

In this example, a battery charger 500 for charging a secondary battery being an operational power supply in the remote controller 200 is provided at a fixed position such as, for example, a position near the left part as it faces the screen in the liquid crystal television 100, and the remote controller 200 is connected to this battery charger 500 to charge the internal secondary battery during unused time. As described later, the remote controller 200 has a current position calculating section for detecting the position of itself as a relative position to the position of the liquid television 100, but it is configured such that cumulative errors related to the detected position are reset at the time when connection to the battery charger 500 is established.

The remote controller 200 is placed at a position shown by the broken line and connected to the battery charger 500 at a contact area (not shown) to its internal secondary battery charged during unused time, and is picked up so that its position and posture are changed as its travel trail is shown with a one-dot chain line during used time, and its front end is pointed to the liquid crystal television 100 when the liquid crystal television 100 is remotely operated. For one example of characteristic handling for the embodiment of the present invention, as described later, the eventual posture shown by a solid line is achieved by way of the posture shown by the one-dot chain line intentionally in the process of eventually achieving the above-mentioned position/posture, or as shown by the void arrow, the user is recognized or certified by movement such as the swinging of a neck at a fixed position, or the like.

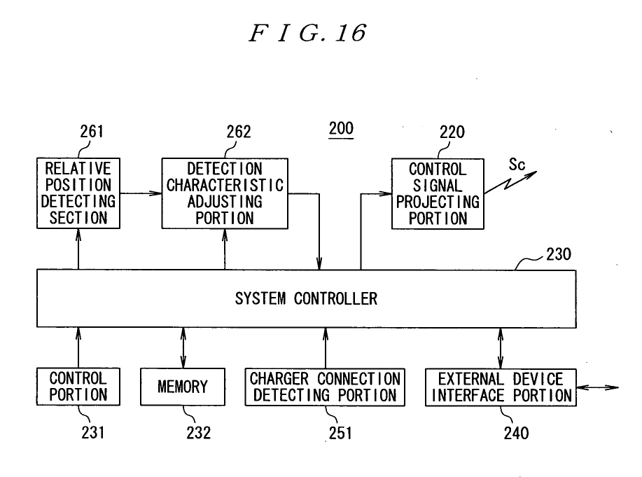

FIG. 15 is a block diagram showing the circuit configuration of the liquid crystal television 100 of FIG. 14. A broadcast wave received by the antenna 110 is demodulated by the demodulation/filtering portion 120, a transport stream is extracted, and filtering for acquiring the images and sounds and program information of a channel selected by the viewer (user) is performed. The image output of the demodulation/filtering portion 120 is supplied to the image processing portion 130, the sound output is supplied to the sound processing portion 140, and the program information is supplied to the OSD portion 150.

The image is projected onto the liquid crystal display device 160 via the liquid crystal driving portion 131 by the output of the image processing portion 130. Program information and other information is displayed on the screen of the liquid crystal display device 160 in such a manner that it is superimposed on the above-mentioned image or it occupies an area in the screen based on the output of the OSD portion 150. Pointing described later is also performed by displaying a specific marker or the like at an intended position on the screen of the liquid crystal display device 160 via the OSD portion 150.

The output of the sound processing portion 140 is supplied via left and right amplifiers 141 and 142 to corresponding left and right speakers 143 and 144 to produce stereo sounds. The system controller 170 including as a main component a microprocessor so as to provide supervisory control for the entire system of the liquid crystal television 100 including the demodulation/filtering portion 120, the sound processing portion 140 and the OSD portion described above is provided.

This system controller 170 is adapted to be supplied with the output of the operation system 171 comprising an operation key and the like for accepting an operation by the viewer (user), and the memory 172 is accessibly connected thereto so that data (information) is stored and read in required timing. The system controller 170 is adapted to function as sections as principal constitutional requirements of the present invention by actions of relevant functions.

Connection is established so that the output of a remote control signal receiving portion 181 provided to receive the control signal Sc behind the light receiving window 105 previously described with reference to FIG. 14 is supplied to the system controller 170 via a remote control signal decode portion 182 comprising a signal amplification circuit and the like and converting a signal received by the remote control signal receiving portion 181 into a signal compatible with handling in the system controller 170.

The left amplifier 141 and the right amplifier 142 described previously are each supplied with a control signal from the system controller 170 to adjust the amplification factor, whereby a balance adjustment of the stereo sounds is made, but particularly in this example, this balance adjustment can be appropriately made in accordance with the location (position/direction) of the remote control (hence, viewer having the remote control) as described later.

In the above description, an information receiving section receiving current position information representing a current position of the remote controller (remote control) generated and transmitted on the remote controller 200 side in relation to a position of the apparatus is constituted by the remote control signal receiving portion 181 and the remote control signal decode portion 182, and an operation mode selecting section selecting an operation mode based on the current position information received by the information receiving section is constituted by relevant functional portions of the system controller 170.

FIG. 16 is a block diagram showing the circuit configuration of the remote controller 200 in the control system of FIG. 14. The independent housing 201 described with reference to FIG. 14 is provided with a relative position detecting section 261 constituted by a well known inertial sensor and so called a gyro detecting a relative change in the position of itself in a noncontact manner. A detection characteristic adjusting section 262 adjusting a detection characteristic in the relative position detecting section 261 by, for example, performing filtering processing is provided, and connection is established so that its output is supplied to the system controller 230.

The system controller 230 comprises as a main component a microprocessor so as to provide supervisory control for the circuit system of the remote controller 200 and performing various operations, and is adapted to function as sections as principal constitutional requirements of the present invention by actions of its relevant functional portions. The control signal projecting portion 220 comprising a light emitting element such as an infrared LED emitting the control signal Sc by infrared light or the like, described with reference to FIG. 14, emits a required control signal Sc according to a command from the system controller 230 described above.

To the system controller 230, an operation signal from an operation portion 231 provided in the housing 201 of the remote controller 200 and having an operation key for performing a channel switching operation and the like is input, and further the memory 232 is connected so that an access can be made to give and receive data, and the external device interface 240 for communicating with the external information processing apparatus such as a personal computer is connected.

This remote controller 200 is provided with a charger connection detecting portion 251 detecting a connection state particularly when the remote controller 200 is connected to the battery charger 500 described with reference to FIG. 14, and connection is established so that the detection output thereof is input to the system controller 230. The operation of reset of cumulative errors of the calculated position related to the remote controller 200 briefly described with reference to FIG. 14 is started in response to the detection output by the charger connection detecting portion 251.

FIG. 17 is a flowchart showing the outline of an operation of the control system (liquid crystal television system) 100+200 as an embodiment of the present invention comprising the liquid crystal television 100 and the remote controller 200 described above. The embodiment of the present invention will be described further in detail below with reference to this flowchart and the previously described drawings as appropriate. The flowchart of FIG. 17 is abstracted so that it is applicable in common for a plurality of ways of alterations.

In FIG. 17, first, on the side of the remote controller 200 having the configuration of FIG. 16, after the operation is started, its relative position detecting section 261 detects a relative change in the position of itself, and the detection output is subjected to appropriate detection characteristic adjustment processing by the detection characteristic adjusting section 262 and supplied to the system controller 230, whereby the current position calculating section constituted by relevant functional portions of the system controller 230 calculates a current position of the remote controller (remote controller 200) in relation to a position of the apparatus (liquid crystal television 100) to generate current position information representing the position (S201).

Here, in detection characteristic adjustment processing, the output characteristic of the current position calculating section is adjusted so as to be compatible with a sensitiveness characteristic and a response characteristic required according to the purpose of the position calculation operation in the position calculating section, or characteristics of the degree of filtering and the like. By the detection characteristic adjustment processing, a detection output of a characteristic serving the purpose, hence the certainty and accuracy of the operation as the remote controller are ensured, and the certainty and accuracy of the operation of the corresponding apparatus are ensured.

Then, by the system controller 230 (its relevant functional portion) and the control signal projecting portion 220 as the information transmitting section, the current position information generated at S201 is converted into the control signal Sc by infrared light or the like, projected and thereby transmitted (S202), and this projected signal Sc is received by the remote control signal receiving portion 181 of the liquid crystal television 100 of FIG. 15, subjected to predetermined signal conversion via the remote control signal decode portion 182, and supplied to the system controller 170 (S101).

The information receiving section is constituted by the remote control signal receiving section 181, the remote control signal decode portion 182 and the system controller 170 (its relevant functional portion). Current position information of the remote control received by the information receiving section in the manner described above is decoded by the system controller 170 (its relevant functional portion) (S102), selection of operation modes such as, for example, selection of contents and selection of directivity of sounds by speakers 143 and 144 is performed by the operation mode selecting section by the system controller 170 (its relevant functional portion) based on the current position information thus decoded (S103), and a series of scheduled processing is completed.

Here, selection of contents based on current position information of the remote control is, for example, an operation of preferentially selecting contents compatible with a specific viewer highly probably situated at the position (e.g. the master of a family in the case of the position on the side of the screen of the liquid crystal television 100, the wife in the case of the position opposite to the center, a child in the case of the intermediate position, etc.) and projecting the same, or the like. As a specific configuration, information as criteria for selection of the contents is prepared in the memory 172 of the liquid crystal television 100 described with reference to FIG. 15 with the information previously integrated into a lookup table, so that by making a reference to the lookup table as appropriate, appropriate selection can be performed.

Selection of directivity of sounds by speakers 143 and 144 is performed such that a command is issued from the system controller 170 according to the relative position of the remote controller 200 to the liquid crystal television 100, and the amplification factors of left and right amplifiers 141 and 142 are adjusted to adjust the sound volumes of left and right speakers 143 and 144, whereby sound orientations are adjusted so that looking and listening can be optimum at a location of the remote controller 200 (it is estimated that the viewer is situated near this location).

On the remote controller 200 side, processing to be performed is by and large completed after current position information is transmitted at step S202, but if in accordance with a usual use method, the remote controller 200 is returned back to the battery charger 500 described with reference to FIG. 14, and connected so that the internal secondary battery is charged, the detection output of the charger connection detecting portion 251 detecting a state of connection to the battery charger 500 is input to the system controller 230 as described with reference to FIG. 16.

In response to the detection output by the connection detecting portion 251, cumulative errors related to the calculated position by the current position calculating section are reset by a functional portion as a cumulative error reset section of the system controller 230 (S203). Namely, at the time when the detection output of the charger connection detecting portion 251 is recognized, the value of the current position of the remote controller 200 is made to coincide with the position of coordinates at which the battery charger 500 is placed. Thus, processing on the remote control side is completed.

Since cumulative errors related to the calculated position by the current position calculating section can be reset each time when the remote control is returned back to the battery charger 500, i.e. its home position, and connection is established for charging as described above, the certainty of position information related to the calculated position by the current position calculating section is maintained, hence the certainty and accuracy of the operation as the remote controller are kept at a high level, and the certainty and accuracy of the operation of the corresponding apparatus are kept at a high level.

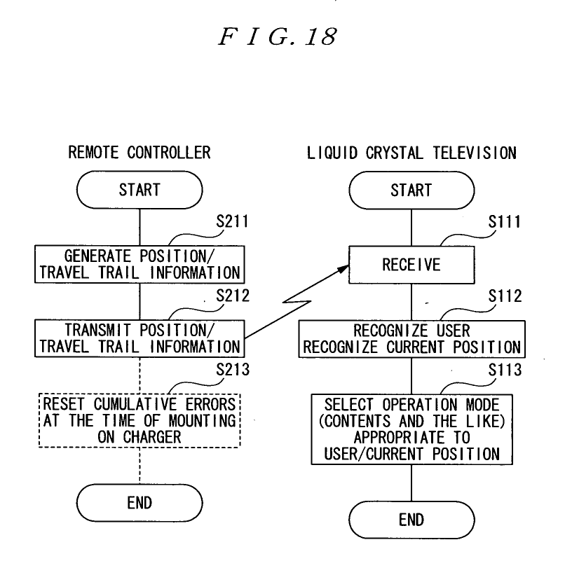

FIG. 18 is a flowchart showing the outline of an operation of the control system (liquid crystal television system) 100+200 as another embodiment of the present invention comprising the liquid crystal television 100 and the remote controller 200. In FIG. 18, first, on the side of the remote controller 200 having the configuration of FIG. 16, the relative position detecting section 261, the detection characteristic adjusting section 262, and the current position calculating section constituted by a relevant portion of the system controller 230 calculate a current position of the remote controller (remote controller 200) to generate current position information representing the position in a manner same as that described with reference to FIG. 17 after the operation is started, but in this example, further, travel trail information related to a travel trail of the remote controller 200 is also generated by a travel trail information generating section by the relevant functional portion of the system controller 230 (S211).

Then, current position information and travel trail information generated at step S211 is transmitted to the liquid crystal television 100 as the apparatus by the information transmitting section (step S212) as in the case of step S202 of FIG. 17, and on the liquid crystal television 100 side, the information is received by the information receiving section (S111), a user is recognized by a user recognizing section constituted by the system controller 170 (its relevant functional group) based on the received travel trail information, and further a current position of the remote control is recognized from current position information (S112) There are various methods for recognizing the user, but an example thereof will be described.

An operation mode (contents, orientations of sounds and the like) depending on the user and the current position of the remote control recognized at step S112 (S113). The step S113 is an operation of preferentially selecting contents compatible with a specific viewer (corresponding to the user in S113) at step S103 of FIG. 17 and projecting the same, or the like. For a specific configuration, information of a tendency of taste for each user is prepared, for example, in the memory 172 with the information integrated into a lookup table, so that by making a reference thereto as appropriate, appropriate selection can be performed, but further, depending on the current position of the remote control, orientations of sounds are adjusted to be appropriate.

Recognition of the user based on travel trail information at step S112 is performed in the following manner, for example. Namely, in FIG. 14, when the remote controller 200 is held by hand by the user and traveled from a home position (shown by the broken line) during unused time where the remote controller 200 is connected to the battery charger 500 to its used position (shown by the solid line) by way of a travel route such as a trail L1 shown by the one-dot chain line, the recognition of the user is performed by a method in which a current user is determined from a characteristic in the tendency of the travel trail.

After the operation at step S212 on the remote control side, cumulative errors related to the calculated position by the current position calculating section is reset (S213) in the same manner as in step S203 described with reference to FIG. 17, and processing is completed. The operation on the liquid crystal television side is completed with performance of the step S113 described above. The remote control can be multi-functionalized so that one remote control can cope with a plurality of televisions and stereos, or recorders, even air conditioners and the like.

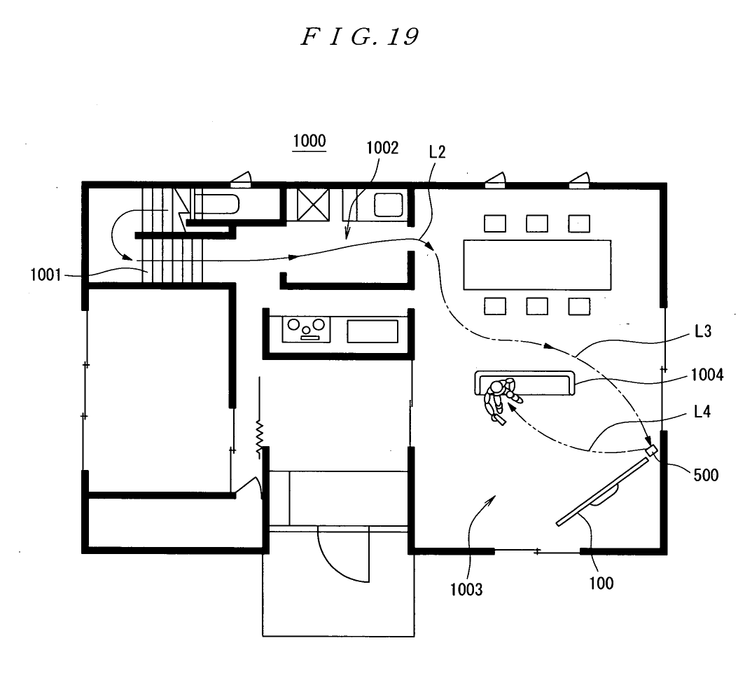

FIG. 19 is a view explaining a method in which if the remote control is a multifunctional device, and one user of a plurality of users such as, for example, a family travels with the remote control in a house according to an opportunity for controlling various household electric products, the user is automatically determined. Now, in a house (home) 1000, a travel trail representing a path line where the user goes down a staircase 1001 from a second floor (not shown), then goes through a wet room 1002, and arrives at a dining room 1003 in which the liquid crystal television 100 is installed is L2.

A travel trail representing a path line whereafter arriving at the dining room 1003, the user travels in the dining room 1003 for taking the remote controller 200 placed in the battery charger 500 near the left side of the liquid crystal television 100 while making a detour behind a sofa 1004 is L3. Further, a travel trail representing a path line where the user holds the remote controller 200 by hand and is seated at his or her home position in the sofa 1004 is L4. The remote control is made to learn the characteristics of these travel trails L2, L3, L4 and the like by a well known method as appropriate, and a current user is determined from correlation between the actual travel trail and the characteristics accumulate by learning.

If the user travels by way of a location such as the above-mentioned staircase 1001 where a characteristic acceleration acts while holding the remote control as in this use example, a correspondence relation between the location of the staircase 1001 and a detection output signal related to a change in relative position detected with a remarkable characteristic by the relative position detecting section 261 by an inertia sensor or the like at this location may be used to perform the reset of cumulative errors described above at a unique site such as the staircase 1001 instead of performing the reset at a time of placing the remote control on the battery charger and establishing connection therebetween.

Giving attention to the fact that the current position of the user holding the remote control can be correctly known in relation to such a specific site in a house, it is recommended that the system should be constructed so that occurrence of operations going against the intention of the user and wasteful power consumption is alleviated, e.g. if it is recognized that the user is in a library (not shown) on the second floor, operations of generation of control signals related to devices other than a device to be controlled, which is installed in the library, are prohibited, and if it is recognized that the user is in the dining room 1003, operations of generation of control signals related to devices other than devices installed there are prohibited.

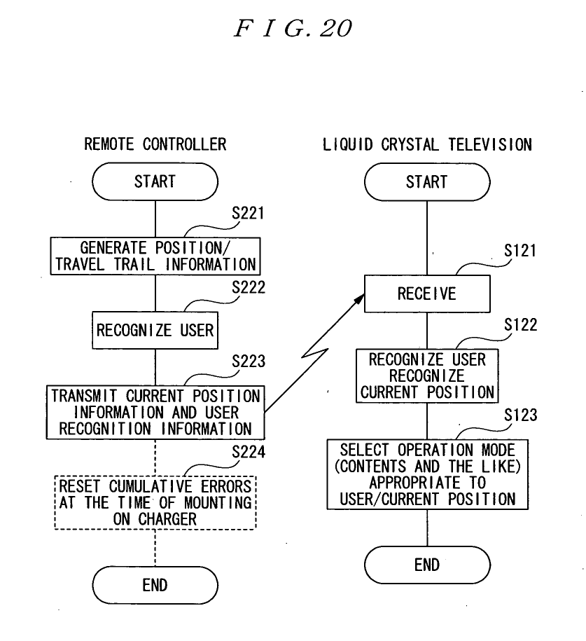

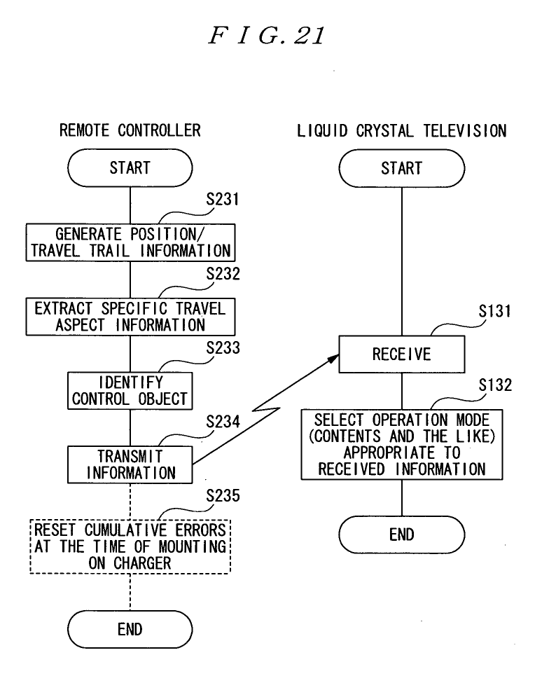

FIG. 20 is a flowchart showing the outline of an operation of the control system (liquid crystal television system) 100+200 as another embodiment comprising the liquid crystal television 100 and the remote controller 200. In FIG. 20, first, on the side of the remote controller 200 having the configuration of FIG. 16, after the operation is started, the relative position detecting section 261, the detection characteristic adjusting section 262, and the current position calculating section constituted by a relevant functional portion of the system controller 230 calculate a current position of the remote controller (remote controller 200) to generate current position information representing the position in a manner same as that described with reference to FIG. 18, and further, travel trail information related to the travel trail of the remote controller 200 is generated by a travel trail information generating section by a relevant functional portion of the system controller 230 (S221).

Then, a user is recognized by a user recognizing section constituted by the system controller 230 (its relevant functional portion) based on the travel trail information generated at step S221 (S222). User recognition information representing the user recognized at step S222 and current position information previously generated at step S221 are transmitted to the liquid television 100 as an apparatus by the information transmitting section (S223) in the same manner as in step S202 of FIG. 17, and on the liquid crystal television 100 side, the information is received by the information receiving section (S121).

Then, on the liquid crystal television 100 side, current positions of the user and the remote control are recognized based on the information received at step S121 (S122). The operation mode (contents, sound orientations and the like) is selected in the same manner as in step S113 depending on the current positions of the user and the remote control recognized at step S122 (S123). The step S123 is an operation of preferentially selecting contents compatible with a specific viewer (corresponding to user in S113) and projecting the same at step S103 of FIG. 17, or the like.

For a specific configuration, information of a tendency of taste for each user is prepared, for example, in the memory 172 with the information integrated into a lookup table, so that by making a reference thereto as appropriate, appropriate selection can be performed, but further, depending on the current position of the remote control, sound orientations are adjusted to be appropriate. After the operation at step S223 on the remote control side, cumulative errors related to the calculated position by the current position calculating section are reset in a manner same as that in step S203 described with reference to FIG. 17 (S224) and processing is completed. The operation on the liquid crystal television side is completed with performance of the step S123 described above.

FIG. 21 is a flowchart showing the outline of an operation of the control system (liquid crystal television system) 100+200 as still another embodiment of the present invention comprising the liquid crystal television 100 and the remote controller 200. In FIG. 21, first, on the side of the remote controller 200 having the configuration of FIG. 16, after the operation is started, the relative position detecting section 261, the detection characteristic adjusting section 262, and the current position calculating section constituted by a relevant functional portion of the system controller 230 calculate a current position of the remote controller (remote controller 200) to generate current position information representing the position in a manner same as that described with reference to FIG. 20, and further, travel trail information related to the travel trail of the remote controller 200 is generated by a travel trail information generating section by a relevant functional portion of the system controller 230 (S231).

Then, when specific travel aspect information destined to correspond to a specific behavior of the user is included in the travel trail information generated at step S231, specific travel aspect information is extracted based on the information by a specific travel aspect information extracting section constituted by the system controller 230 (its functional portion) (S232). A specific behavior of the user and specific travel aspect information herein will be described with reference to the drawings.

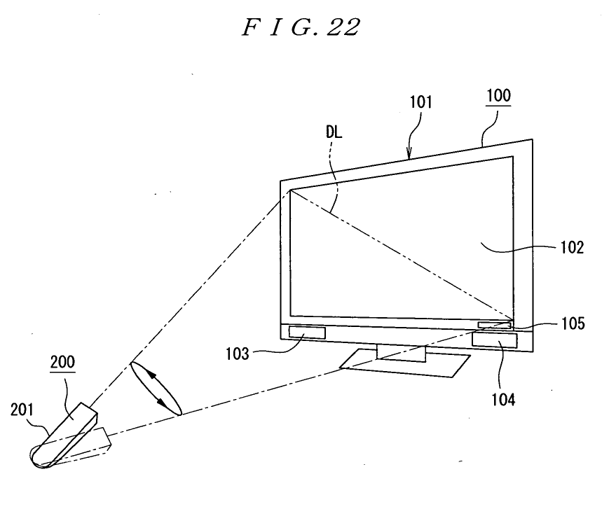

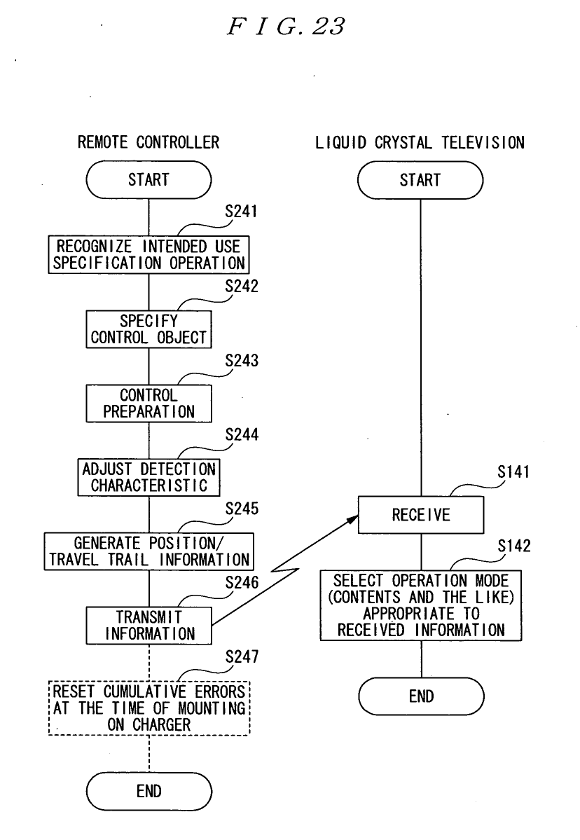

FIG. 22 is a conceptual view explaining a situation in which the user holds a remote control and takes a specific behavior with respect to the apparatus destined to be a control object, whereby the remote control is made to recognize the apparatus. The liquid crystal television 100 in FIG. 22 is same as that described with respect to FIG. 14, and is provided in its housing 101 with the screen 102 onto which an image is projected, the left speaker 103 and the right speaker 104 constituting a stereo type sound apparatus at a location lower than the bottom side of the screen 102, and the light receiving window 105 receiving a control signal by infrared light or the like from the remote controller 200 just right below the bottom side of the screen 102.

Now, when a user (not shown) holds the remote controller 200, and intentionally takes a specific behavior for making the remote control recognize what the apparatus is, specific travel aspect information destined to correspond to the specific behavior is generated. Namely, the user behaves such that a diagonal line is followed from the left upper end of the screen to the right lower end with the remote controller 200 in, for example, one round travel, at a position at a predetermined distance (e.g. proper visible and audible distance) from the screen 102 of the liquid crystal television 100.

When the above-mentioned behavior is relevant to specific travel aspect information destined to correspond to a specific behavior of the user in advance in light of the previously described current position information generated by the relative position detecting section 261 composed of an inertial sensor and the like of the remote controller 200, the detection characteristic adjusting section 262, and the current position calculating section constituted by a relevant functional portion of the system controller 230, and travel trail information generated by the travel trail information generating section by a relevant functional portion of the system controller 230, a specific travel aspect information extracting section by a relevant functional portion of the system controller 230 extracts the specific travel aspect information. For the above-mentioned specific behavior, the movement of each specific aspect which can be discriminated for each specification of the apparatus destined to be a control object may be assigned at the time of initial learning.

Description will now return to the flowchart of FIG. 21. When specific travel aspect information is extracted at step S232, then an apparatus to be controlled as an apparatus corresponding to the specific travel aspect extracted by a control object identifying section by a relevant functional portion of the system controller 230 is identified (S233), and information representing the position and travel trail of the control apparatus (remote controller) is transmitted by the information transmitting section to the apparatus (liquid crystal television 100 in this example) with a signal of an aspect compatible with the apparatus (S234).

As described above, in this embodiment, for example, information of a current position of the remote controller and information of a command or the like for performing a desired operation can be reliably transmitted to the apparatus with a signal of an aspect compatible with an apparatus identified as an apparatus to be controlled. On the side of the liquid crystal television 100 as the apparatus in this example, information transmitted at step S234 is received (S131), and selection of an operation mode or the like is performed based on the received information (S132) in a manner same as that described with reference to FIG. 17, 18 or 20.

After the operation at step S234 on the remote control side, cumulative errors related to the position calculated by the current position calculating section are reset (S235) in a manner same as that in step S203 described with reference to FIG. 17, and processing is completed. The operation on the liquid crystal television side is completed with performance of the step S132 described above.

FIG. 23 is a flowchart showing an operation of still another embodiment of the present invention. The remote controller 200 is similar to that of FIG. 16 in configuration on the block diagram, and the liquid crystal television 100 as the apparatus is similar to that of FIG. 15. An operation of selecting the type of intended use is performed by the user on an operation portion of the remote controller 200, and an intended use recognizing section by a relevant functional portion of the system controller 230 recognizes the intended use (S241).

The intended use is, for example, use of the remote controller 200 as a pointing device or for determination of the user. There may be a plurality of devices relevant to the intended use recognized at step S241. For example, a television applied for the same pointing object may be either a large liquid crystal television suitable for watching in a large numbers of people or a smaller type.

Therefore, as described with reference to FIG. 22, the user takes a behavior of pointing the remote controller 200 at the screen 102 and following its diagonal line DL in one round travel for, for example, the liquid crystal television 100 intended for use to make the remote controller 200 specify an apparatus to be actually used in the same manner as in steps S 231 to 233 of FIG. 21 (S242). For performing the step S242, the relative position detecting section, the travel trail information generating section, the specific travel aspect information extracting section and the control object identifying section same as those with FIG. 21 function.

In the remote controller 200, operations of preparation for control such as selection of the type of a control command signal (code) and definition of functions of operation keys of the operation portion 231 are performed so as to be compatible with the apparatus (liquid crystal television 100 in this example) specified at step S242 (S243) Then, by the detection characteristic adjusting section 262 (and a relevant functional portion of the system controller 230), the detection characteristic of the relative position detecting section 261 composed of an inertial sensor is adjusted so as to be compatibles with the apparatus specified at step S242 and the intended use recognized at step S241 (S244).

Based on the detection output of the relative position detecting section 261 actuated with the detection characteristic adjusted at step S244, position information and travel trail information are generated as described previously (S245), and the information is transmitted to the apparatus (liquid crystal television 100) with a signal of an aspect compatible with the apparatus to be controlled, identified by the control object identifying section (S246) On the liquid crystal television side, the transmitted information can be received (S141), and an intended operation such as pointing can be normally performed depending on the received information (S142).

After the operation at step S246 on the remote control side, cumulative errors related to the calculated position by the current position calculating section are reset in a manner same as that in step S203 described with reference to FIG. 17 (S247) and processing is completed. The operation on the liquid crystal television side is completed with performance of the step S142 described above. According to the embodiment described with reference to FIG. 22, the detection characteristic such as, for example, a detection sensitivity characteristic can be optimized according to the intended use, and thereafter, desired detection is performed by the detection output of the relative position detecting section in this state, and information of, for example, a command for performing a desired operation can be reliably transmitted to the apparatus with a signal of an aspect compatible with the apparatus as the result of the identification described above.

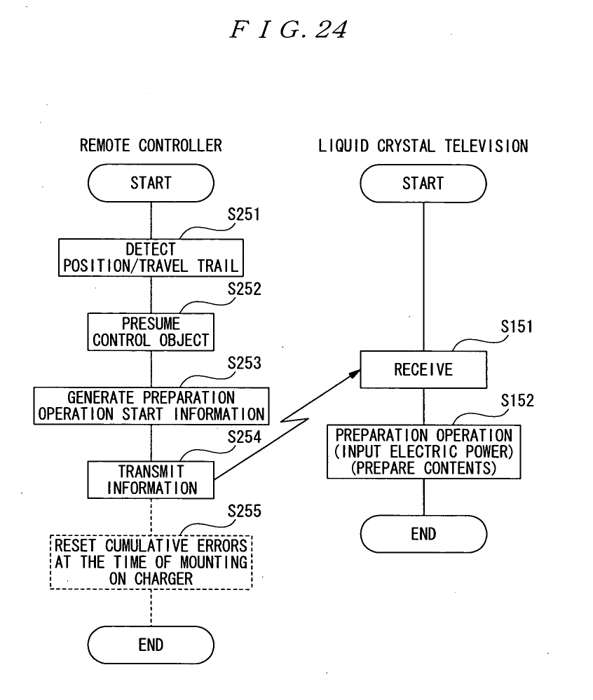

FIG. 24 is a flowchart showing the outline of an operation of the control system (liquid crystal television system) 100+200 as another embodiment of the present invention comprising the liquid crystal television 100 and the remote controller 200. In FIG. 23, first, on the side of the remote controller 200 having the configuration of FIG. 16, after the operation is started, the relative position detecting section 261, the detection characteristic adjusting section 262, and the current position calculating section constituted by a relevant functional portion of the system controller 230 calculate a current position of the remote controller (remote controller 200) to generate current position information representing the position in a manner same as that described with reference to FIG. 18, and further, travel trail information related to the travel trail of the remote controller 200 is generated by a travel trail information generating section by a relevant functional portion of the system controller 230 (S251).

Then, an apparatus to be controlled is presumed by a control object presuming section by a relevant functional portion of the system controller 230 based on the travel trail information generated at step S251 (S252). Then, preparation operation start information for the apparatus to be controlled, presumed at step S252, to start a preparation operation for operation is generated by a preparation operation start information generating section (S253).

Here, the preparation operation for operation is, for example, an operation equivalent to an intended operation such as supply of an electric power and preparation of contents. Information including the preparation operation start information generated at step S253 is transmitted to the apparatus (liquid crystal television 100 in this example) by the previously described information transmitting section (S254). On the liquid crystal television 100 side, the preparation operation start information is received (S151), and an operation equivalent to an intended operation such as supply of an electric power and preparation of contents as described above is performed in response to the received preparation operation start information (S152).

After the operation at step S254 on the remote control side, cumulative errors related to the position calculated by the current position calculating detection are reset in a manner same as that in step S203 described with reference to FIG. 17 (S255), and processing is completed. The preparation operation on the liquid crystal television side is completed with performance of the step S152 described above. According to the embodiment described with reference to FIG. 23, the apparatus to be controlled is presumed based on travel trail information of a travel trail along a path line of the user traveling toward a specific apparatus, for example.

In the example described with reference to FIG. 19, for example, travel trails L2, L3 and the like represent a course where a master of a family travels toward the battery charger 500 of the remote control of the liquid crystal television 100 in the dining room 1003, it can be thus presumed that the apparatus to be controlled is the liquid crystal television 100, and therefore preparation operation start information for the apparatus thus presumed to start a preparation operation such as, for example, supply of an electric power and preparation of contents is generated. On the side of the liquid crystal television 100 receiving the preparation operation start information, the above-mentioned preparation operation can be started in response to the information, thus making it possible to achieve a system excellent in responsiveness when seen from the user side.

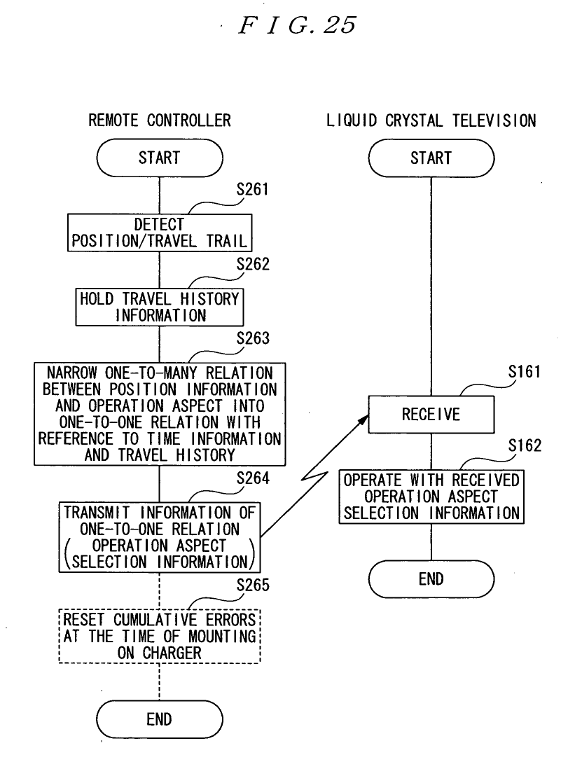

FIG. 25 is a flowchart showing the outline of an operation of the control system (liquid crystal television system) 100+200 as still another embodiment of the present invention comprising the liquid crystal television 100 and the remote controller 200. In FIG. 25, first, on the side of the remote controller 200 having the configuration of FIG. 16, after the operation is started, the relative position detecting section 261, the detection characteristic adjusting section 262, and the current position calculating section constituted by a relevant functional portion of the system controller 230 calculate a current position of the remote controller (remote controller 200) to generate current position information representing the position in a manner same as that described with reference to FIG. 18, and further, travel trail information related to the travel trail of the remote controller 200 is generated by a travel trail information generating section by a relevant functional portion of the system controller 230 (S261).

Travel history information representing a form of a travel position or travel trail of the remote controller 200 in time sequence related to information obtained at step S261 is held one by one by a travel history holding section by a relevant functional portion of the system controller 230 (S262). The relation between the current position information generated at step S261 and the operation aspect on the apparatus corresponding to the position varies depending on a time, and therefore their relation is a one-to-many relation.

For example, even if the remote control is present at the same position, pieces of news related to whether broadcasts and traffic conditions have a high priority as contents in the early morning of a weekday, and contents related to arts and entertainments have a high priority in a time zone of holiday night.

Thus, in this embodiment, a user is presumed by travel history information held at step S262, while clocking operation is performed by a time managing section by a relevant functional portion of the system controller 230 to obtain time information, and considering a time-dependent behavior type of the presumed user, processing of narrowing the above-mentioned one-to-many relation between current position information and the operation aspect on the apparatus side into a one-to-one relation by an operation aspect selection information generating section by a relevant functional portion of the system controller 230 is performed (S263). The processing at step S263 is, in other words, to generate operation aspect selection information specifying an operation aspect that should be taken by the apparatus at any time point.

Operation aspect selection information representing the relation between current position information and the operation aspect on the apparatus side, narrowed into a one-to-one relation at step 263, is transmitted to the liquid crystal television 100 side by the previously described information transmitting section (S264). On the liquid crystal television 100 side, the operation aspect selection information is received (S161), and selection of an operation mode such as selection of contents is performed based on the received operation aspect selection information (S162).

After the operation at step S264 on the remote control side, cumulative errors related to the position calculated by the current position calculating section are reset in a manner same as that in step S203 described with reference to FIG. 17 (S265), and processing is completed. The operation on the liquid crystal television side is completed with performance of the step S162 described above. According to the embodiment described with reference to FIG. 24, an operation aspect which should be taken by the apparatus (liquid crystal television 100) at a managed time (any time point) is selected considering information of travel history of the remote controller (remote controller 200) and information of the current position of the remote controller 200, whereby operation aspect selection information can be generated and transmitted to the apparatus side. On the side of the apparatus receiving the operation aspect selection information, an operation of an aspect with consideration given to the above-mentioned information can be selected.

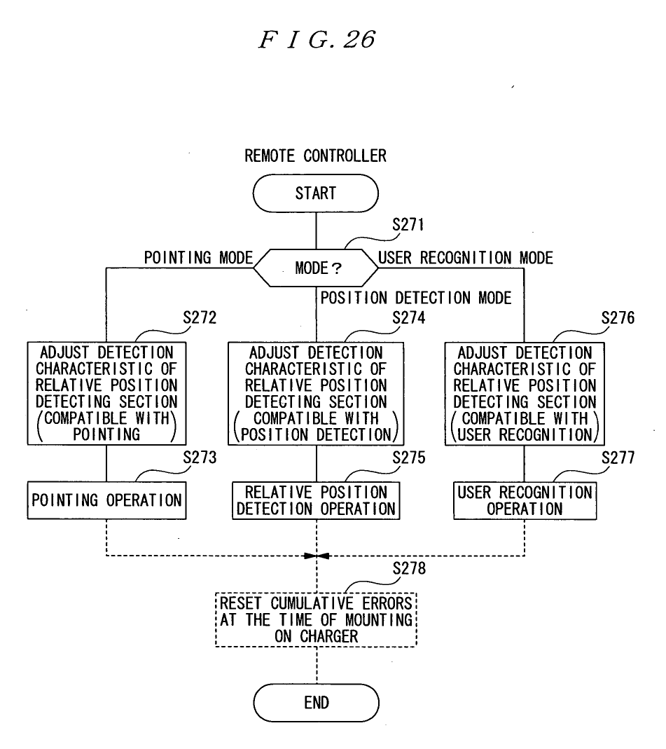

FIG. 26 is a flowchart showing an operation of still another embodiment of the present invention. In this embodiment, the remote control as the remote controller has a configuration shown in FIG. 16 as a block diagram, and comprises a pointing information generating section (relevant functional portion of system controller 230) generating pointing information for specifying a position on the display screen (screen 102) of the apparatus (e.g. liquid crystal television) based on the detection output on the relative position detecting section 261 and performing pointing, a travel trail information generating section (relevant functional portion of system controller 230) generating travel trail information related to the travel trail of the remote controller 200 based on the detection output of the relative position detecting section 261, and a user recognizing section (relevant functional portion of system controller 230) generating user recognition information for recognizing a user based on travel trail information generated by the travel trail information generating section and showing the recognition.

The remote control further comprises a mode selecting section (relevant functional portion of system controller 230) selecting any of three modes: a position detection mode for detecting the position of itself based on current position information by the current position calculating section, a pointing mode for specifying a position on the screen 102 of the liquid crystal television 100 based on the above-mentioned pointing information, and a user recognition mode for recognizing a user based on the above-mentioned user recognition information.

In the initial stage of the operation, this remote controller (remote controller 200) determines an operation mode selected by a user operation on its own operation portion 231 (S271). When the result of determination at step S271 is the pointing mode, the detection characteristic of the relative position detecting section 261 is adjusted by the detection characteristic adjusting section 262 so as to be compatible with the pointing mode (S272), and a predetermined pointing operation is performed based on the detection output of the relative position detecting section 261 with the detection characteristic thus adjusted (S273).

When the result of determination at step S271 is the position detection mode, the detection characteristic of the relative position detecting section 261 is adjusted by the detection characteristic adjusting section 262 so as to be compatible with the position detection mode (S274), and a predetermined position detection operation is performed based on the detection output of the relative position detecting section 261 with the detection characteristic thus adjusted (S275). When the result of determination at step S271 is the user recognition mode, the detection characteristic of the relative position detecting section 261 is adjusted by the detection characteristic adjusting section 262 so as to be compatible with the user recognition mode (S276), and a predetermined user recognition operation is performed based on the detection output of the relative position detecting section 261 with the detection characteristic thus adjusted (S277).

After the pointing operation (S273), the position detection operation (S275) and the user recognition operation (S277) are completed, cumulative errors related to the position calculated by the current position calculating section in a manner same as that in step S203 described with reference to FIG. 17 (S278), and processing is completed. In the embodiment of FIG. 25, the certainty and accuracy of the operation s the remote controller are maintained at a high level, and hence the certainty and accuracy of the operation on the apparatus side are maintained at a high level because any of the position detection mode for detecting the position of itself, the pointing mode for specifying a position of the display screen of the relevant apparatus and performing pointing, and the user recognition mode for recognizing a user can be selectively taken to function, and the detection characteristic by the relative position detecting section is adjusted so as to be appropriate to a selected mode.

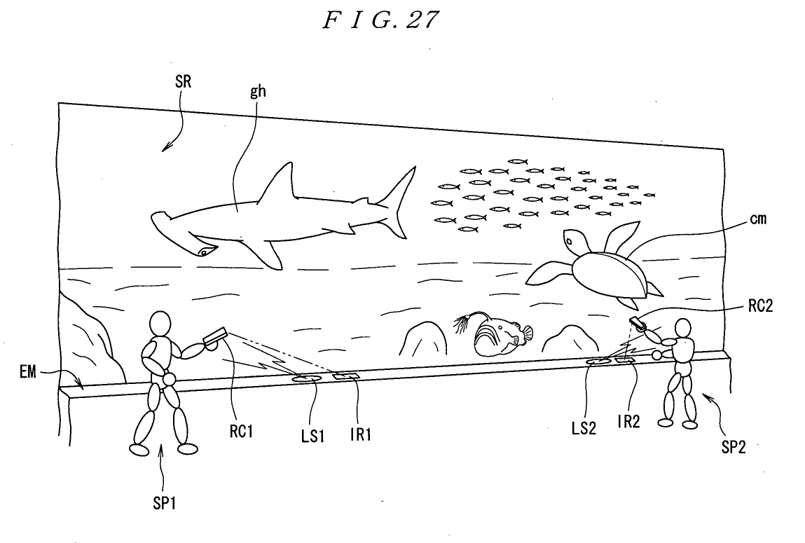

FIG. 27 is a conceptual view showing a embodiment in which the present invention is applied to an automatic explanation apparatus in an aquarium. The example shown in the figure is a system in which explanations by sounds are automatically broadcasted in appropriate timing for living organisms in a panoramic giant migration aquarium. An appliance housing portion EM shielding cables, electric circuits and other appliances is formed in such a manner as to protrude by forming steps on the front side zonally along the lower side of a transparent screen SR made from an acryl thick plate, and a shoulder of the appliance housing portion EM is provided with infrared signal light receiving portions IR1, IR2, . . . at appropriate intervals and further provided with speakers LS1, LS2, . . . giving off sounds for explanations such that they are adjacent to the infrared signal light receiving portions IR1, IR2, . . . , respectively.

Spectators SP1, SP2, . . . . have remote controls RC1, RC2 . . . each comprising a relative position detecting section having a configuration substantially same as that of FIG. 16. In the remote controls RC1, RC2 . . . , the current position and the travel trail are detected as described previously, respectively, based on the detection output of the relative position detecting section, information representing the detected result is automatically transmitted to infrared signal light receiving portions IR1, IR2, . . . with signals by infrared light, and by an appliance provided in the appliance housing portion EM, positions of corresponding remote controls RC1, RC2 . . . , and hence positions of spectators SP1, SP2, . . . are recognized.

When positions of the spectators SP1, SP2, . . . (remote controls RC1, RC2 . . . ) are recognized, explanations for a living organism within the field of view of spectators or coming into the field of view of spectators are broadcasted toward the spectators SP1, SP2, . . . from the speakers LS1, LS2, . . . placed near the positions of the spectators SP1, SP2, . . . , respectively. Namely, a position of a living organism in the aquarium to be explained is determined by, for example, detecting in the passive sonar principle a signal generated by an ultrasonic wave tag attached to each individual, and a living organism in the field of view of spectators is determined according to the positions of the spectators recognized based on signals from the remote controls RC1, RC2 . . . , and relevant explanations are broadcasted from the speakers LS1, LS2 . . . .

If the spectator SP1 situated to the left of the screen SR operates a relevant sound start request button of the operation portion using the remote control RC1 at the time when explanations are desired, the position is recognized in the manner described above, and from the speaker LS1 situated at a position nearest to the spectator SP1, explanations like “it is great hammerhed shark that is now swimming across in front of the customer having remote control No. 1”., “it is fish of Carcharhiniformes, Sphyrnidae, and inhabits in temperate or tropical sea in the world. Some individuals grow to the length of 6 meters, and the fish is one of the largest of Sphyrnidae. . . . ” are broadcasted in directivity from the speaker LS1 toward the spectator SP1 for great hammerhed shark gh just swimming across the field of view of the spectator SP1.

Similarly, for the spectator SP2 situated to the right of the screen SR and looking at a green turtle cm just before his or her eyes, explanations like “it is a green turtle that is now in front of the customer having remote control No. 2.”, “the green turtle is a reptile of Chelonia, Cheloniidae, and inhabits in tropical or temperate sea, and also in Mediterranean sea, and some have a shell length of 80 centimeters to 1 meter or greater . . . ” are broadcasted in directivity from the speaker LS2 to the spectator SP2. Even if explanations described above are broadcasted from the speakers LS1 and LS2 at the same time, the spectators SP1 and SP2 can listen and look without much concern for interferences because explanations for the object give attention by each spectator are broadcasted in directivity compatible with each spectator.

What has been described above is an example in which the present invention is applied to a panoramic large aquarium, but for a relatively small aquarium in which a limited number of kinds of living organisms are subdivided, fed and presented on exhibition, a comfortable automatic explanation system producing sounds which are very easily listened to even under a somewhat dark and noisy situation if explanations compatible with the field of view of the spectator are broadcasted in optimum or adaptive directivity according to the position of the spectator.

In the above embodiment in which the present invention is applied to an aquarium, explanations may be displayed on a display provided in the remote control in some cases. In a small aquarium in particular, the extent within which living organisms to be explained travel is limited, and therefore an appliance in which a signal of an ultrasonic wave tag attached to each living organism is caught by a passive sonar as in a large aquarium may be omitted.

FIG. 7 described previously is also a conceptual view showing an embodiment in which the remote controller (remote controller 200) operates in liaison with an external information processing apparatus through a communication section (external device interface 240 described previously with reference to FIG. 16) in a control system substantially same as the control system (liquid crystal television system) 100+2 00 described with reference to FIG. 14. In FIG. 7, parts corresponding to those in FIG. 14 are given same symbols.

The liquid crystal television 100 is configured to be capable of receiving a control signal by infrared light or the like from the remote controller 200 corresponding to the liquid crystal television 100 to have its operation controlled. The liquid crystal television 100 has in its housing 101 the screen 102 onto which an image is projected, the left speaker 103 and the right speaker 104 constituting a stereo type sound apparatus at a location lower than the bottom side of the screen 102, and the light receiving window 105 receiving a control signal Sc (shown by a tow-dot chain line) by infrared light or the like from the remote controller 200 just right below the bottom side of the screen 102.

The remote controller 200 has the independent housing 201 capable of being placed at a location distant from the liquid crystal television 100 (its housing 101). The inner configuration is similar to that of FIG. 16 on the block diagram. The control system (liquid crystal television system) 100+200 of the present invention is configured to include the above mentioned liquid crystal television 100 and remote controller 200. This embodiment is similar to the embodiment described with reference to FIG. 14 in that the control signal Sc includes a signal representing various kinds of information related to communication between the liquid crystal television and the remote control in addition to a signal representing information itself for controlling the liquid crystal television 100 according to any operation by an operator.

As described previously with reference to FIG. 16, the remote controller 200 comprises the external device interface 240 as the communication section communicating with a personal computer (hereinafter referred to as PC) 300 as an external information processing apparatus. More strictly, the communication section is configured to include relevant functional portions and the like of the external device interface 240 and the system controller 230 to which the external device interface 240 is connected.

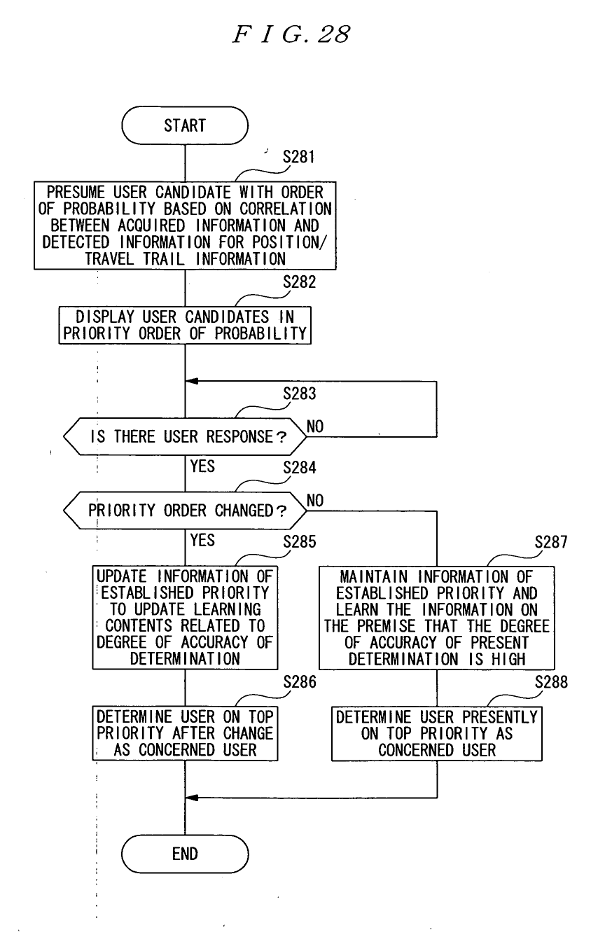

The PC 300 is further connected to an internet 400, and therefore various data can be acquired through the internet 400 and made use of in addition to data held by itself. Thus, according to the control system of FIG. 28, the function of the external information processing apparatus is made use of through the communication section in addition to the action by the control system of FIG. 14, whereby a still higher level of control can be performed with a simple configuration without considerably increasing a burden on the remote controller itself.

For performing the operation described with reference to FIGS. 14 to 25, in the remote controller 200, it is required to get required learning done in advance and store the result thereof in the memory 231. If the layout of the interior of the house as described with reference to FIG. 19 is changed by reconstruction or the like, or the layout of the interior of the house is not changed, but the layout of the liquid crystal television or other furniture is changed to change the expected user's path line of the present system, it is required to revise the learning contents on every such occasion.

In the system in FIG. 7, various conveniences can be provided for the user such that a support program is provided for newly learning in response to such a change, or information is obtained through the above-mentioned communication section such as making available a method for obtaining a floor plan corresponding to a layout after revision, or a guide or support is received if the layout of the interior of the house belongs to an established pattern, and so on.

In processing for recognition (expressed as “determination” in the description with reference to FIG. 19, and thus hereinafter described as “determination”) of a user in the system described above, automatic determination based on the position or travel trail of the remote control has been described, but a method of an interactive man-machine interface may be incorporated in the processing. Namely, any of processing at step S112 on the apparatus (liquid crystal television 100) side in FIG. 18, processing at step S222 on the control apparatus (remote controller 200) side in FIG. 20 and processing at step S277 on the control apparatus (remote controller 200) side in FIG. 13 involves automatic determination, but an interactive method may be incorporated in this user determination processing.

FIG. 28 is a flowchart explaining an example in which an interactive method is incorporated in user determination processing. This flowchart is abstracted so as to accommodate both user determination processing being performed on the control apparatus (remote controller 200) side and user determination processing being performed on the apparatus (liquid crystal television 100) side. In this processing, first, for information of the position or travel trail (hereinafter referred to as travel trail information) of the remote controller 200 being the control apparatus (hence user holding it), the order of probability of being the user is estimated based on a correlation between obtained information related to a correspondence between the travel trail information and the user (initially, appropriate information of so called a default value is set) and newly detected information (S281), and display is provided so that a real user can be recognized (S282).

If the display is provided in the remote controller 200, a liquid crystal display portion of a well known aspect is provided and display is provided thereon, or a signal for display may be transmitted to the corresponding liquid crystal television to provide display on its screen. One waits until a response regarding whether a determination on a priority is appropriate or not is made from the user as a result of visually recognizing the display (S283), and whether a change instruction from the real user for the displayed priority exists or not is determined according to the contents of response (S284).

When the change instruction for the priority is provided from the user (in this case, the user name displayed on the top in display at step S282 is not the name of the real user, and from the real user, a change instruction is issued by an appropriate operation such as moving a cursor and pressing down a determination button at a relevant point for placing himself on the top), information of the established priority is updated to update learning contents (statistic value of an occurrence frequency for each correspondence between travel trail information and the user) related to the degree of accuracy of determination (S285).

After step S285, the user of whose priority after update is on the top (namely, user for which an operation is performed for placing himself on the top) is determined as a determination object (S286). When no change instruction for the priority is provided (in this case, the user name displayed on the top in display at step S282 is just the name of the real user, and the real user indicates that the present determination is correct by an appropriate operation such as pressing down a determination button), and information of the established priority is maintained and learned on the premise that accuracy of determination on the present priority is high (S287).

If information of the established priority is updated and the real user changes his or her priority to the top as in step S285, the user on the top in the changed priority is determined as a concerned user (S286), and on the other hand, if information of the established priority is not updated as in step S287, the user presently on the top priority is determined as a concerned user (S288), and user determination processing is completed.

By incorporating the method of the interactive man-machine interface described above in user determination processing, the accuracy of determination can be improved as the number of uses is increased, thus making it possible to achieve a system of which the usability improves with use. Thus, for users of similar characters and conducts, discrimination can be performed with high accuracy and a correct determination can be made. Even if one user once made to learn a specific movement (motion such as changing the posture of the remote control or swinging the remote control) to determine himself has his motion read by another user, the privacy can be protected by making the present system learn a different motion or a different correspondence between the travel trail and the user.

In the various embodiments of the present invention described above, in a device of an aspect such as the previously described remote control, the position of a user holding the device or an electronic device which the device is attached to or associated with can be recognized, and therefore if the electronic device is an apparatus receiving electric waves, an application in which a frequency band optimum for receiving electric waves is selected depending on this position is conceivable. Namely, as an example, a frequency band to be applied is selected based on information of a current position if same contents are broadcasted in a plurality of kinds of frequency bands, and so on. Alternatively, if electric waves can received only from satellites on the south side as in mobile broadcasting, electric waves from the satellite are received under a situation in which it is confirmed from information of the position or orientation that an antenna is located on the south side, switching is automatically done so that electric waves are received from a gap filler if not under such a situation, and so on.

In the embodiments described above, Bluetooth®, IEEE802.11b or IEEE802.11g and the like are applicable for communication between apparatuses. Using a personal digital assistant such as a cellular phone as the above-mentioned remote control, switching may be done to a call using a wireless IP network according to information representing a relative position, or Bluetooth® may be used to provide sound information.

1. A control system comprising a remote controller and an apparatus capable of being controlled by the remote controller,
wherein said remote controller comprises:
a housing formed separately from said apparatus;
an image pickup section provided in the housing and adapted to be capable of generating image information including information contributing to recognition of a relative position of said apparatus to the remote controller when imaging is performed toward the side of said apparatus; and
an information transmitting section transmitting image information generated by said image pickup section to the side of said apparatus, and
said apparatus comprises:
an information receiving section adapted to be capable of receiving image information transmitted from the information transmitting section of said remote controller; and
a relative position calculating section calculating a relative position of the apparatus to said remote controller based on image information received by said information receiving section.

2. An apparatus configured to be capable of being controlled from a predetermined remote controller formed separately from the apparatus, comprising:
an information receiving section adapted to be capable of receiving image information generated by an image pickup section provided in said remote controller and including information contributing to recognition of a relative position of the apparatus to said remote controller when image information is transmitted from the side of said remote controller; and
a relative position calculating section calculating the relative position of the apparatus to said remote controller based on image information received by said information receiving section.

3. A remote controller adapted to be capable of performing predetermined control of an apparatus and formed separately of said apparatus, comprising:
an image pickup section provided in its own housing to be capable of generating image information including information contributing to recognition of a relative position of said apparatus to the remote controller when imaging is performed toward the side of said apparatus; and
an information transmitting section transmitting image information generated by said image pickup section to the side of said apparatus.

4. The control system according to claim 1, wherein the relative position calculating section of said apparatus is configured to calculate a relative position of the apparatus to said remote controller based on information contributing to recognition of the relative position of the apparatus to said remote controller in image information received by said information receiving section and information related to the outer dimension of the apparatus, previously prepared to be capable of being used.

5. The apparatus according to claim 2, wherein said relative position calculating section is configured to calculate a relative position of the apparatus to said remote controller based on information contributing to recognition of the relative position of the apparatus to said remote controller in image information received by said information receiving section and information related to the outer dimension of the apparatus, previously prepared to be capable of being used.

6. The control system according to claim 4, wherein said apparatus comprises an information holding section holding said information related to the outer dimension of the apparatus, previously prepared to be capable of being used.

7. The apparatus according to claim 5, further comprising an information holding section holding said information related to the outer dimension of the apparatus, previously prepared to be capable of being used.

8. The control system according to claim 1, wherein the relative position calculating section of said apparatus is configured to calculate a relative position of the apparatus to said remote controller using marker information representing a specific position marker as information contributing to recognition of the relative position of the apparatus to said remote controller in image information received by said information receiving section and information related to the outer dimension of the apparatus, previously prepared to be capable of being used.

9. The apparatus according to claim 2, wherein said relative position calculating section is configured to calculate a relative position of the apparatus to said remote controller using marker information representing a specific position marker as information contributing to recognition of the relative position of the apparatus to said remote controller in image information received by said information receiving section and information related to the outer dimension of the apparatus, previously prepared to be capable of being used.

10. The control system according to claim 1, wherein the relative position calculating section of said apparatus comprises a trapezoidal distortion operating section performing an operation for determining a trapezoidal distortion using marker information representing a specific position marker as information contributing to recognition of a relative position of the apparatus to said remote controller in image information received by said information receiving section, and is configured to calculate the relative position of the apparatus to said remote controller using the result of the operation by the trapezoidal distortion operating section and information related to the outer dimension of the apparatus, previously prepared to be capable of being used.

11. The apparatus according to claim 2, wherein said relative position calculating section comprises a trapezoidal distortion operating section performing an operation for determining a trapezoidal distortion using marker information representing a specific position marker as information contributing to recognition of a relative position of the apparatus to said remote controller in image information received by said information receiving section, and is configured to calculate the relative position of the apparatus to said remote controller using the result of the operation by the trapezoidal distortion operating section and information related to the outer dimension of the apparatus, previously prepared to be capable of being used.

12. The control system according to claim 1, wherein said apparatus further comprises a position marker projecting section projecting a specific position marker as information contributing to recognition of a relative position of the apparatus to said remote controller onto its own display portion.

13. The apparatus according to claim 2, further comprising a position marker projecting section projecting a specific position marker as information contributing to recognition of a relative position of the apparatus to said remote controller onto its own display portion.

14. The control system according to claim 1, wherein said apparatus further comprises a coded information pattern projecting section projecting a coded information pattern recognizable by said remote controller onto its own display portion.

15. The apparatus according to claim 2, further comprising a coded information pattern projecting section projecting a coded information pattern recognizable by said remote controller onto its own display portion.

16. The control system according to claim 1, wherein said remote controller further comprises a communication section communicating with an external information processing apparatus.

17. The remote controller according to claim 3, further comprising a communication section communicating with an external information processing apparatus.

18. The control system according to claim 16, wherein said remote controller further comprises:
an outer shape information acquiring section acquiring information related to the outer shape of one or more apparatus destined to be a control object through said communication section; and
a control object discriminating section discriminating an apparatus to be controlled based on a correlation between information related to the outer shape of the apparatus, acquired by said outer shape information acquiring section, and image information obtained by said image pickup section.

19. The remote controller according to claim 17, further comprising:
an outer shape information acquiring section acquiring information related to the outer shape of one or more apparatus destined to be a control object through said communication section; and
a control object discriminating section discriminating an apparatus to be controlled based on a correlation between information related to the outer shape of the apparatus, acquired by said outer shape information acquiring section, and image information obtained by said image pickup section.

20. The control system according to claim 1, wherein said remote controller comprises:
an outer shape information holding section holding information related to the outer shape of one or more apparatus destined to be a control object; and
a control object discriminating section discriminating an apparatus to be controlled based on a correlation between image information obtained by said image pickup section and information related to the outer shape of the apparatus, held by said outer shape information holding section.

21. The remote controller according to claim 3, further comprising:
an outer shape information holding section holding information related to the outer shape of one or more apparatus destined to be a control object; and
a control object discriminating section discriminating an apparatus to be controlled based on a correlation between image information obtained by said image pickup section and information related to the outer shape of the apparatus, held by said outer shape information holding section.

22. The control system according to claim 20, wherein the outer shape information holding section of said remote controller holds an image related to the outer shape of said one or more apparatus destined to be a control object, acquired by previously picking up the image by the image pickup section.

23. The remote controller according to claim 21, wherein said outer shape information holding section holds an image related to the outer shape of said one or more apparatus destined to be a control object, acquired by previously picking up the image by the image pickup section.

24. A control system comprising a remote controller and an apparatus capable of being controlled by the remote controller,
wherein said remote controller comprises:
a housing formed separately from said apparatus;
an image pickup section provided in the housing and adapted to be capable of generating image information including information contributing to recognition of a relative position of said apparatus to the remote controller when imaging is performed toward the side of said apparatus;
a communication section communicating with an external information processing apparatus; and
an information acquiring and transmitting section transferring image information generated by said image pickup section to the image processing apparatus through said communication section, acquiring relevant information related to said apparatus, supplied from said information processing apparatus as a response to the transfer, and transmitting the relevant information to the side of said apparatus, and
said apparatus comprises:
an information receiving section adapted to be capable of receiving the relevant information transmitted from the information acquiring and transmitting section of said remote controller;
a relative position recognizing section recognizing a relative position of the apparatus to said remote controller using the relevant information received by said information receiving section; and
an adjustment section performing a predetermined adjustment operation based on the recognition by said relative position recognizing section.

25. An apparatus configured to be capable of being controlled from a predetermined remote controller formed separately from the apparatus, comprising:
an information receiving section adapted to be capable of transferring image information generated by said remote controller with its image pickup section to an external image processing apparatus through its own communication section and receiving relevant information related to said apparatus, acquired from the information processing apparatus as a response to the transfer;
a relative position recognizing section recognizing a relative position of the apparatus to said remote controller using the relevant information received by said information receiving section; and
an adjustment section performing a predetermined adjustment operation based on recognition by said relative position recognizing section.

26. A remote controller adapted to be capable of performing predetermined control of an apparatus and formed separately from said apparatus, comprising:
an image pickup section provided in its own housing to be capable of generating image information including information contributing to recognition of a relative position of said apparatus to the remote controller when imaging is performed toward the side of said apparatus;
a communication section communicating with an external information processing apparatus; and
an information acquiring and transmitting section transferring image information generated by said image pickup section to the information processing apparatus through said communication section, acquiring relevant information related to said apparatus, supplied from said information processing apparatus as a response to the transfer, and transmitting the relevant information to the side of said apparatus.

27. The control system according to claim 24, wherein the information acquiring and transmitting section of said remote controller is configured to further acquire signal form information representing a form of a signal applied for carrying information transmitted to said apparatus through said communication section as relevant information related to said apparatus and transmit information to said apparatus with a signal of an aspect compliant with the acquired signal form information.

28. The remote controller according to claim 26, wherein said information acquiring and transmitting section is configured to further acquire signal form information representing a form of a signal applied for carrying information transmitted to said apparatus through said communication section as relevant information related to said apparatus and transmit information to said apparatus with a signal of an aspect compliant with the acquired signal form information.

29. The control system according to claim 24, wherein said apparatus further comprises a coded information pattern projecting section projecting a coded information pattern recognizable by said remote controller onto its own display portion.

30. The apparatus according to claim 25, further comprising a coded information pattern projecting section projecting a coded information pattern recognizable by said remote controller onto its own display portion.

31. The control system according to claim 24, wherein said apparatus further comprises a marker and coded information pattern projecting section projecting a plurality of markers and a coded information pattern including information representing intervals between the plurality of markers by a code recognizable by said remote controller onto its own display portion.

32. The apparatus according to claim 25, further comprising a marker and coded information pattern projecting section projecting a plurality of markers and a coded information pattern including information representing intervals between the plurality of markers by a code recognizable by said remote controller onto its own display portion.

33. A control system comprising a remote controller and an apparatus capable of being controlled by the remote controller,
wherein said remote controller comprises:
a housing formed separately from said apparatus;
an image pickup section provided in the housing and adapted to be capable of generating image information including information contributing to recognition of a relative position of said apparatus to the remote controller when imaging is performed toward the side of said apparatus;
an outer shape information holding section holding information related to the outer shape of one or more apparatus destined to be a control object;
a control object discriminating section discriminating an apparatus to be controlled based on correlation between image information acquired by said image pickup section and information held by said outer shape information holding section;
a relative position calculating section calculating a relative position of said apparatus to the remote controller using information related to an outer shape of an apparatus discriminated as an apparatus by said control object discriminating section and held by said outer shape information holding section and image information acquired by said image pickup section; and
an information transmitting section transmitting information representing the relative position of said apparatus to the remote controller calculated by said relative position calculating section to said apparatus, and
said apparatus comprises:
an information receiving section adapted to be capable of receiving information representing the relative position of said apparatus to the remote controller transmitted from the information transmitting section of said remote controller; and
an adjustment section performing a predetermined adjustment operation based on information received by said information receiving section.

34. A remote controller adapted to be capable of performing predetermined control of an apparatus and formed separately from said apparatus, comprising:
an image pickup section provided in its own housing to be capable of generating image information including information contributing to recognition of a relative position of said apparatus to the remote controller when imaging is performed toward the side of said apparatus;
an outer shape information holding section holding information related to the outer shape of one or more apparatus destined to be a control object;
a control object discriminating section discriminating an apparatus to be controlled based on correlation between image information acquired by said image pickup section and information held by said outer shape information holding section;
a relative position calculating section calculating a relative position of said apparatus to the remote controller using information related to an outer shape of an apparatus discriminated as an apparatus by said control object discriminating section and held by said outer shape information holding section and image information acquired by said image pickup section; and
an information transmitting section transmitting information representing the relative position of said apparatus to the remote controller calculated by said relative position calculating section to said apparatus.

35. A control system comprising a remote controller and an apparatus capable of being controlled by the remote controller,
wherein said remote controller comprises:
a housing formed separately from said apparatus;
a relative position detecting section provided in the housing and detecting in a noncontact manner a relative change in the position of itself;
a current position calculating section calculating a current position of the remote controller in relation to a position of said apparatus based on a detection output of said relative position detecting section, and generating current position information representing the current position; and
an information transmitting section transmitting to outside the current position information generated by said current position calculating section, and
said apparatus comprises:
an information receiving section receiving the current position information transmitted from the information transmitting section of said remote controller; and
an operation mode selecting section selecting an operation mode based on the current position information received by said information receiving section.

36. An apparatus configured to be capable of being controlled by a predetermined remote controller formed separately from the apparatus, comprising:
an information receiving section receiving current position information when said remote controller calculates a current position of the remote controller in relation to a position of the apparatus depending on a detection output of its own relative position detecting section and transmits position information representing the position to outside as current position information; and
an operation mode selecting section selecting an operation mode based on the current position information received by said information receiving section.

37. A remote controller adapted to be capable of performing predetermined control of an apparatus and having a housing separate from said apparatus, comprising:
a relative position detecting section provided in said housing and detecting in a noncontact manner a relative change in the position of itself;
a current position calculating section calculating a current position of the remote controller in relation to a position of said apparatus based on a detection output of said relative position detecting section, and generating current position information representing the current position; and
an information transmitting section transmitting to outside the current position information generated by said current position calculating section.

38. The remote controller according to claim 37, further comprising a detection characteristic adjusting section making an adjustment so that the detection output of said relative position detecting section has a characteristic compatible with a current position calculation operation in said current position calculating section.

39. The remote controller according to claim 37, further comprising a cumulative error resetting section resetting cumulative errors included in current position information generated by said current position calculating section.

40. The remote controller according to claim 37, wherein said remote controller further comprises a travel trail information generating section generating travel trail information related to the travel trail of the remote controller based on the detection output of said relative position detecting section, and said information transmitting section is configured to transmit also travel trail information generated by said travel trail information generating section to outside.

41. The apparatus according to claim 36, wherein said information receiving section is configured to receive also travel trail information related to the travel trail of the remote controller, transmitted from the information transmitting section of said remote controller, and said apparatus further comprises a user recognizing section recognizing a user based on the travel trail information received by said information receiving section.

42. The remote controller according to claim 37, wherein said remote controller further comprises:
a travel trail information generating section generating travel trail information related the travel trail of the remote controller based on the detection output of said relative position detecting section; and
a user recognizing section recognizing a user based on travel trail information generated by said travel trail information generating section and generating user recognition information representing the recognition, and
said information transmitting section transmits also user recognition information generated by said user recognizing section to outside.

43. The apparatus according to claim 36, wherein said information receiving section is configured to receive also user recognition information representing a user recognized on the remote controller side, transmitted from the information transmitting section of said remote controller, and said apparatus further comprises an operation mode selecting section selecting an operation mode according to user recognition information received by said information receiving section.

44. The remote controller according to claim 37, wherein said remote controller comprises:
a travel trail information generating section generating travel trail information related to the travel trail of the remote controller based on the detection output of said relative position detecting section;
a specific travel aspect information extracting section extracting specific travel aspect information when the specific travel aspect information destined to correspond to a specific behavior of a user is included in travel trail information generated by said travel trail information generating section; and
a control object identifying section identifying an apparatus to be controlled based on specific travel aspect information extracted by said specific travel aspect information extracting section, and
said information transmitting section is configured to transmit information by a signal of an aspect compatible with the apparatus to be controlled, identified by the control object identifying section.

45. The remote controller according to claim 37, wherein said remote controller further comprises:
an intended use recognizing section recognizing the type of intended use based on an operation on its own operation portion;
a travel trail information generating section generating travel trail information related to the travel trail of the remote controller based on the detection output of said relative position detecting section;
a specific travel aspect information extracting section extracting specific travel aspect information when the specific travel aspect information destined to correspond to a specific behavior of a user is included in travel trail information generated by said travel trail information generating section;
a control object identifying section identifying an apparatus to be controlled, compatible with said intended use, based on specific travel aspect information extracted by said specific travel aspect information extracting section; and
a detection characteristic adjusting section making an adjustment so that the detection output of said relative position detecting section has a characteristic compatible with the result of identification by said control object identifying section and said intended use, and
said information transmitting section is configured to transmit information with a signal of an aspect compatible with the apparatus to be controlled, identified by the control object identifying section.

46. The remote controller according to claim 37, wherein said remote controller further comprises:
a travel trail information generating section generating travel trail information related to the travel trail of the remote controller based on the detection output of said relative position detecting section;
a control object presuming section presuming an apparatus to be controlled based on travel trail information generated by said travel trail information generating section; and
a preparation operation start information generating section generating preparation operation start information making the apparatus presumed to be an apparatus to be controlled by said control object presuming section start a preparation operation for operation, and
said information transmitting section is configured to transmit preparation operation start information generated by said preparation operation start information generating section to the apparatus to be controlled, presumed by said control object presuming section.

47. The remote controller according to claim 37, wherein said remote controller further comprises:
a time managing section performing a clocking operation and outputting time information;
a travel history holding section holding travel history information representing the travel history of the remote controller so that a reference can be made to the travel history information; and
an operation aspect selection information generating section generating operation aspect selection information specifying an operation aspect which should be taken at any time point by said apparatus, based on position information generated by said current position calculating section, time information output by said time managing section, and travel history information held by said travel history holding section, and
said information transmitting section is configured to transmit operation aspect selection information generated by said operation aspect selection information generating section to outside.

48. The remote controller according to claim 37, further comprising:
a pointing information generating section generating pointing information for specifying a position on a display screen of an apparatus and performing pointing based on the detection output of said relative position detecting section;
a travel trail information generating section generating travel trail information related to the travel trail of the remote controller based on the detection output of said relative position detecting section;
a user recognizing section recognizing a user based on travel trail information generated by said travel trail information generating section and generating user recognition information representing the recognition; and
a mode selecting section selecting any of modes: a position detection mode for detecting the position of itself based on current position information by said current position calculating section, a pointing mode for specifying a position on a display screen of an apparatus and performing pointing based on said pointing information, and a user recognition mode for recognizing a user based on said user recognition information.

49. The remote controller according to claim 48, further comprising a detection characteristic adjusting section adjusting a detection characteristic by said relative position detecting section according to a mode selected by said mode selecting section.
